(19) United States
(12) Patent Application Publication
(10) Pub. No.: US 2012/0187678 A1
(43) Pub. Date: Jul. 26, 2012

(54) TUBE FITTING

(75) Inventors: Peter C. Williams, Cleveland Heights, OH (US); George A. Carlson, Ravenna, OH (US); Andrew P. Marshall, University Heights, OH (US); Mark A. Clason, Orwell, OH (US); Mark A. Bennett, Bainbridge Township, OH (US); Jeffrey M. Rubinski, WIckliffe, OH (US); Mark D. Bearer, Akron, OH (US); Dale C. Arstein, Highland Heights, OH (US)

(73) Assignee: SWAGELOK COMPANY, Solon, OH (US)

(21) Appl. No.: 13/303,246

(22) Filed: Nov. 23, 2011

Related U.S. Application Data
(63) Continuation of application No. 11/993,037, filed on Oct. 23, 2009, now abandoned.
(60) Provisional application No. 60/694,185, filed on Jun. 27, 2005.

(51) Int. Cl. F16L 19/08; F16L 19/06; F16L 21/02; F16L 19/02

(52) U.S. Cl. 285/342; 285/335; 285/354

(57) ABSTRACT

Fittings are provided for use with different types of tubing. One such fitting includes a gripping member having a sharp tube indenting edge that provides a seal between the tube gripping member and the tube. Another such fitting includes a tube gripping member having a body indenting edge that provides a seal between the tube gripping member and a fitting body.

### CROSS REFERENCE TO RELATED APPLICATION

This application is a continuation application of U.S. Ser. No. 11/993,037, filed Oct. 23, 2009 for TUBE FITTING which is the U.S. national phase entry of PCT/US2006/024776, with an international filing date of Jun. 26, 2006, which claims the benefit of U.S. Provisional patent application Ser. No. 60/694,185 filed on Jun. 27, 2005 for FITTING FOR THIN WALLED TUBE, the entire disclosures of which are fully incorporated herein by reference.

### FIELD OF THE INVENTION

The present invention relates to tube fittings.

### BACKGROUND OF THE INVENTION

Many existing fittings, particularly fittings used with thin walled tube, require a flare to be produced at the tube end. Prior art FIG. 1 illustrates an example of an existing fitting 2 that is used with flared tubing 12, such as, for example, flared thin walled tubing. The fitting 2 includes a body 3, a sleeve 4, and a nut 5. The nut and sleeve are placed over the tube and the tube end 6 is flared. The flared tube end 6 is held between a fitting nose 7 and the sleeve 4 by the nut 5. The flared tube end increases the assembly time, the cost of the fitting, and requires the tube to be moved axially with respect to the fitting during assembly and disassembly, which may be difficult in some fluid systems.

### SUMMARY

According to one aspect of the present application, a fitting is provided that limits plastic deformation of a tube to which the fitting is assembled. As one example, plastic deformation may be limited to a narrow ring of engagement between the tube and a tube indenting edge on a tube gripping member. In one embodiment, this narrow ring of engagement may be achieved by providing the tube indenting edge of the tube gripping member with a sharp radius, which may focus the indenting or cutting engagement between the tube gripping member and the tube to a narrow ring. A narrow ring of engagement may additionally or alternatively be achieved by hardening at least the tube indenting edge of the tube gripping member, such as with a low temperature carburization process, to minimize deformation of the tube indenting edge during fitting assembly and, as a result, to minimize the region of contact between the tube indenting edge and the tube. Since the region of engagement between the tube gripping member and the tube is reduced, the amount of force required to be applied by the fitting member to plastically deform the tube material is likewise reduced. This may be of particular benefit in use with thin walled tubing, which may be able to support the significantly reduced force that is applied to the tube along a narrow ring of engagement with a tube gripping member. As a result, when such a fitting is used with thin walled tube, the thin walled tube may not need to be flared and placed over a fitting member.

According to another aspect of the present application, a fitting may additionally or alternatively be configured to reinforce or back up an end of the tubing, thereby providing support for the forces applied by the fitting to the tubing, such as the force that is applied by, for example, a tube gripping member, to plastically deform the tube material and form a seal. In one embodiment, an annular groove or recess may be provided in a fitting body end face to receive and reinforce the tube end. In another embodiment, a groove, recess, or other reinforcement structure may be provided in a fitting component assembled with a fitting body, such as a gland or gasket. This aspect may also be of particular benefit in use with thin walled tubing, as support or reinforcement for the end of the tubing may prevent or minimize unwanted deformation of the tubing during pull-up, such as deformation away from a highly localized region of engagement between a fitting member and the thin walled tube. This aspect may also eliminate the need for flaring of the thin walled tube, as the fitting is adapted to support or reinforce an unaltered tube end.

According to yet another aspect of the present invention, a fitting may be configured such that the a tube may be assembled with or separated from a fitting body without substantial axial movement of the tube with respect to the fitting body, thereby allowing separation or assembly with substantially zero clearance between the fitting body and the tube. In one such embodiment, the tube end abuts an end face of the fitting body. As such, the tube would not need to be axially withdrawn from an end of the fitting body during disassembly. In another embodiment, a sealing structure, for example on a tube gripping member or on another fitting component, seals against an end face of the fitting body. As such, the sealing structure would not need to be axially withdrawn from an end of the fitting body during disassembly. Additionally, when used with thin walled tubing, the elimination of a flared end on the tubing, as described above, may also facilitate assembly and disassembly of the fitting with substantially zero clearance.

Other aspects of the present application may also be provided, alone or in combination, with the above aspects, with various exemplary fittings, to facilitate ease of assembly, sealing capability, adaptability for use with various types of tubing and in various types of systems and applications, as well as other benefits. These other aspects include, but are not limited to: providing a fitting component with a damping portion that engages the tube to limit vibration at the end of the tube assembled with the fitting; providing a hinging mechanism in a tube gripping member to pivot the gripping member into engagement with a tube when a fitting is tightened; providing a flexing mechanism in a tube gripping member to flex the gripping member into engagement with a tube when a fitting is tightened; providing an intermediary sealing member between a tube gripping member and a fitting body; providing a colleting member to transfer a gripping force from a fitting component, such as a fitting body or nut, to a tube gripping member; providing a tube alignment structure, for example, on a fitting body or a sealing member, to axially align a tube within a fitting; providing a separate cam member in a fitting to direct a tube gripping member into engagement with a tube when the fitting is tightened; providing a fitting component, such as a tube gripping member, in a shape memory alloy, such that a gripping force is applied when the component returns to its remembered shape; applying a substance, such as a lubricant, to one or more fitting components to enhance fitting performance; and providing a clamping structure for clamping a tube against a reinforcement structure of a fitting to seal against the tube when the fitting is assembled.

Embodiments of the present application relate to fittings that may be used with thin walled tubing. However, it should be noted that many of the aspects described in the present application may be provided in fittings for use with many types of conduits, including, for example, piping and tubing of varying wall thicknesses, hardnesses, sizes, and materials of construction. In this application, the terms tube, tubing, pipe, piping and conduit may be used interchangeably and each are to be interpreted broadly to include any tube, pipe or conduit.

A fitting according to the present application includes one or more fitting components that may be assembled with a tube. While the embodiments described herein include threaded fitting bodies and nuts, many different fitting arrangements may be used with the various aspects of the present application. One exemplary fitting includes a fitting body, a nut, and an annular tube gripping member. The nut is assembled with the fitting body, and the tube gripping member is assembled between the fitting body and the nut. The tube gripping member has a sharp annular tube indenting edge that plastically deforms the tubing along a narrow ring of engagement when the fitting body and the nut are tightened to provide a seal between the tube gripping member and the tubing.

Another exemplary fitting includes a fitting body, a nut, a reinforcement structure, and an annular tube gripping member. The nut is assembled with the fitting body and has an annular bore. The tube includes a substantially cylindrical end portion that extends through the annular bore. The reinforcement structure engages the end portion of the tube. The annular tube gripping member is assembled between the fitting body and the nut. The annular gripping member presses the cylindrical tube end against the reinforcement structure when the fitting body and the nut are tightened to provide a seal between the tube gripping member and the tubing.

Further advantages and benefits will become apparent to those skilled in the art after considering the following description and appended claims in conjunction with the accompanying drawings.

### BRIEF DESCRIPTION OF THE DRAWINGS

FIG. 1 is an illustration of a prior art flared end type tube fitting;

FIG. 2A is a schematic partial cross-sectional view of a fitting;

FIG. 2B is a schematic partial cross-sectional view of the fitting of FIG. 2A in a pulled up condition;

FIG. 3A is a partial cross-sectional view of an example of a fitting;

FIG. 3B is a partial cross-sectional view of the fitting of FIG. 3A in a pulled up condition;

FIG. 4 is a partial cross-sectional view of an example of a fitting;

FIG. 5A is a partial cross-sectional view of an example of a fitting;

FIG. 5B is a partial cross-sectional view of the fitting of FIG. 5A in a pulled up condition;

FIG. 6 is a partial cross-sectional view of an example of a tube gripping member for a fitting;

FIG. 7 is a partial cross-sectional view of an example of a tube gripping member for a fitting;

FIG. 8A is a partial cross-sectional view of an example of a tube gripping member for a fitting;

FIG. 8B is a partial cross-sectional view of the tube gripping member of FIG. 8A in a pulled up condition;

FIG. 9 is a partial cross-sectional view of an example of a sealing member and a fitting body for a fitting;

FIG. 10 is a partial cross-sectional view of an example of a tube gripping member for a fitting;

FIG. 11 is a partial cross-sectional view of an example of a tube gripping member for a fitting;

FIG. 12 is a partial cross-sectional view of an example of a tube gripping member and a fitting body for a fitting;

FIG. 13 is a partial cross-sectional view of an example of a tube gripping member and a fitting body for a fitting;

FIG. 14 is a partial cross-sectional view of a tube gripping member and a nut for a fitting;

FIG. 15 is a partial cross-sectional view of a tube gripping member and a collet member for a fitting;

FIG. 16 is a partial cross-sectional view of an example of a fitting;

FIG. 17 is a partial cross-sectional view of an example of a fitting;

FIG. 18 is a partial cross-sectional view of an example of a fitting;

FIG. 19 is a partial cross-sectional view of an example of a fitting;

FIG. 20 is a partial cross-sectional view of an example of a tube gripping member and a fitting body for a fitting;

FIG. 21 is a partial cross-sectional view of an example of a tube gripping member and a fitting body for a fitting;

FIG. 22 is a partial cross-sectional view of an example of a fitting body and a gland for a fitting;

FIG. 23 is a partial cross-sectional view of an example of a fitting body and a gland for a fitting;

FIG. 24 is a partial cross-sectional view of an example of a fitting body and a gland for a fitting;

FIG. 25 is a partial cross-sectional view of an example of a fitting body for a fitting;

FIG. 26 is a partial cross-sectional view of an example of a gasket for a fitting;

FIG. 27 is a partial cross-sectional view of an example of a fitting body and a sealing member for a fitting;

FIG. 28 is a partial cross-sectional view of an example of a fitting body and a sealing member for a fitting;

FIG. 29 is a partial cross-sectional view of an example of a fitting;

FIG. 30 is a partial cross-sectional view of an example of a fitting;

FIG. 31 is a partial cross-sectional view of an example of a sealing member and a gripping member for a fitting;

FIG. 32 is a partial cross-sectional view of an example of a sealing member and a gripping member for a fitting;

FIG. 33 is a partial cross-sectional view of an example of a nut, sealing member, and gripping member for a fitting;

FIG. 34 is a partial cross-sectional view of an example of a nut, gasket member, and gripping member for a fitting;

FIG. 35 is a partial cross-sectional view of an example of a tubing end support structure;

FIG. 36 is a partial cross-sectional view of an example of a tubing end support structure;

FIG. 37 is a partial cross-sectional view of an example of a tubing end support structure;

FIG. 38 is a partial cross-sectional view of an example of a tubing end support structure;

FIG. 39 is a partial cross-sectional view of an example of a tubing end support structure;

FIG. 40 is a partial cross-sectional view of an example of a tubing end support structure;

FIG. 41 is a partial cross-sectional view of an example of a fitting;

FIG. 42 is a partial cross-sectional view of an example of a fitting;

FIG. 43 is a partial cross-sectional view of an example of a fitting;

FIG. 44 is a partial cross-sectional view of an example of a gripping member for a fitting;

FIG. 45 is a partial cross-sectional view of the gripping member of FIG. 44 is a gripping condition;

FIG. 46 is a partial cross-sectional view of an example of a fitting;

FIG. 47 is a partial cross-sectional view of an example of a sealing member, gripping member, colleting member, and nut for a fitting;

FIG. 48A is a partial cross-sectional view of an example of a fitting;

FIG. 48B is a partial cross-sectional view of the fitting of FIG. 48A in a pulled up condition;

FIG. 49A is a schematic partial cross-sectional view of a fitting;

FIG. 49B is a schematic partial cross-sectional view of the fitting of FIG. 49A in a pulled up condition;

FIG. 50 is a partial cross-sectional view of an example of a fitting; and

FIG. 51 is a partial cross-sectional view of an example of a fitting.

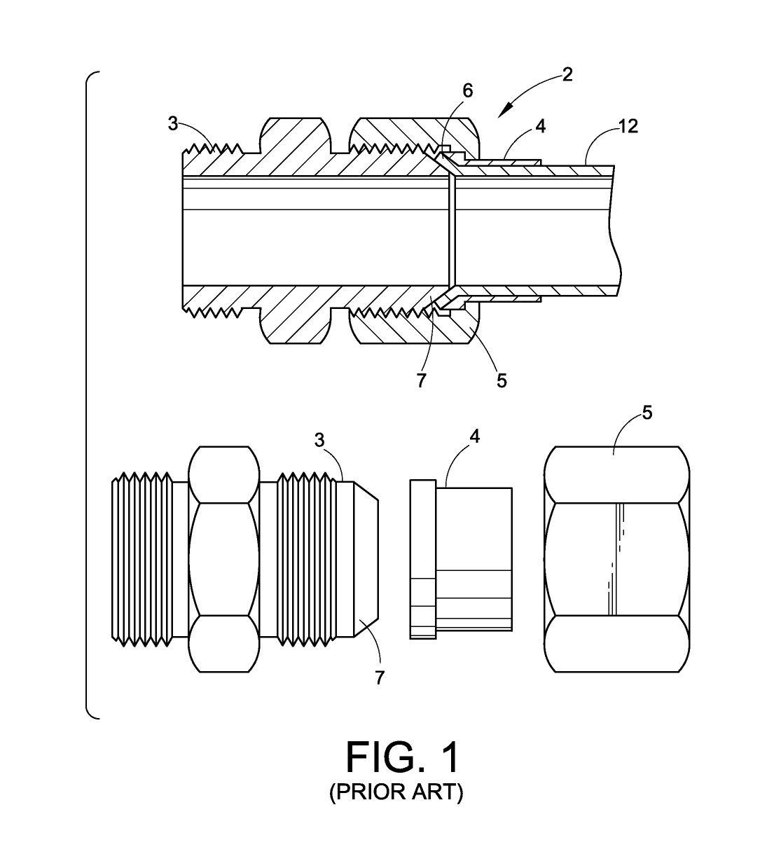

### DETAILED DESCRIPTION

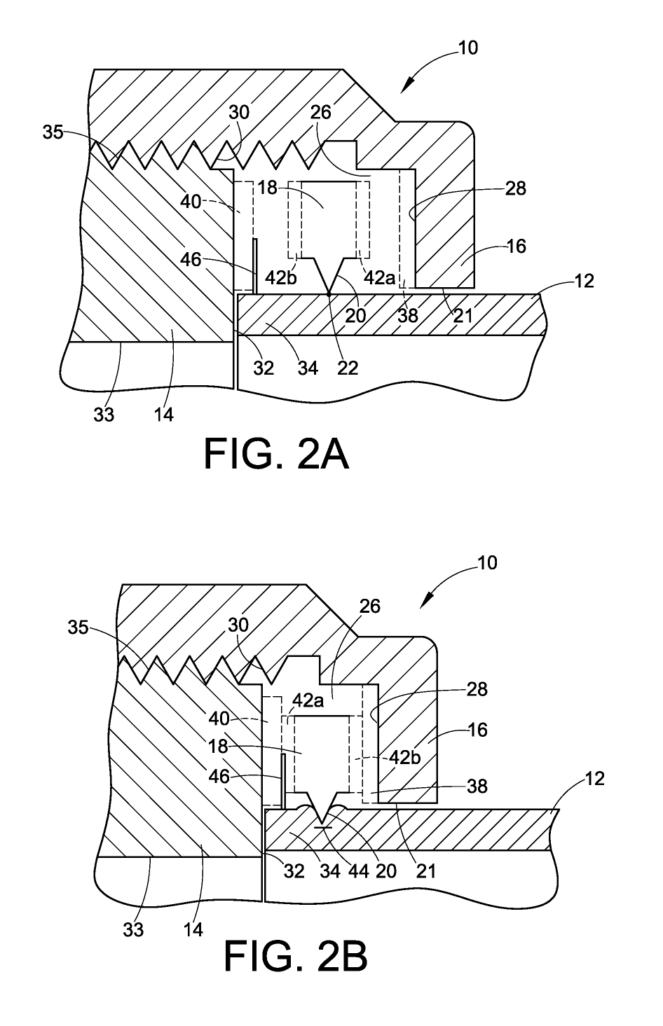

According to one aspect of the present application, a fitting may be configured to apply reduced gripping and/or sealing forces to a tube to which it is assembled. This may, for example, reduce required pull-up torque during assembly or reassembly of the fitting, or reduce deformation of the tube. This may enable a fitting to be used with tubing that cannot withstand the gripping and/or sealing forces of a conventional tube fitting, such as, for example, tubing made of a relatively soft material or thin walled tubing. Tube gripping forces may be reduced using many different mechanisms or configurations. As one example, a fitting may plastically indent or deform a tube along a narrow ring of engagement around the circumference of the tube. The narrow ring of engagement may be either a continuous ring or a discontinuous ring, with discrete locations of engagement around the ring of engagement. In one embodiment, a sharp tube indenting edge is provided on a tube gripping member of the fitting. The sharp edge reduces engagement between the tube gripping member and the tube to a narrow ring of engagement. In another embodiment, a tube indenting edge is hardened, such as with respect to the tube, other fitting components, or other portions of a tube gripping member, to reduce deformation of the tube indenting edge during fitting pull-up. This reduced deformation of the indenting portion reduces engagement between the tube gripping member and the tube fitting to a narrow ring of engagement. Many different mechanisms or configurations may be used to bring a tube indenting edge of a tube gripping member into engagement with a tube. Some examples of such configurations are illustrated and described in the embodiments of FIGS. 2A-8B, 10-18, 20, 21, 29-34, 41-48B, 50 and 51.

According to another aspect of the present application, a fitting may additionally or alternatively be configured to reinforce or back up an end of the tubing, thereby providing support for the forces applied by the fitting to the tubing, such as the force that is applied by, for example, a tube gripping member, to plastically deform the tube material and form a seal. In one embodiment, a reinforcement structure, such as, for example, an annular groove or recess, may be provided in a fitting body end face to receive and reinforce the tube end. In another embodiment, a groove, recess, or other reinforcement structure may be provided in a fitting component assembled with a fitting body, such as a gland or gasket. This aspect may also be of particular benefit in use with thin walled tubing, as support or reinforcement for the end of the tubing may prevent or minimize unwanted deformation of the tubing during pull-up, such as deformation away from a highly localized region of engagement between a fitting member and the thin walled tube. This aspect may also eliminate the need for flaring of the thin walled tube, as the fitting is adapted to support or reinforce an unaltered tube end. Some examples of reinforcement structures that may be used are illustrated and described in the embodiments of FIGS. 2A, 2B, 36-43, 46, and 49A-51.

According to yet another aspect of the present invention, a fitting may be configured such that the a tube may be assembled with or separated from a fitting body without substantial axial movement of the tube with respect to the fitting body, thereby allowing separation or assembly with substantially zero clearance between the fitting body and the tube. In one such embodiment, the tube end abuts an end face of the fitting body. As such, the tube would not need to be axially withdrawn from an end of the fitting body during disassembly. In another embodiment, a sealing structure, for example on a tube gripping member or on another fitting component, seals against an end face of the fitting body. As such, the sealing structure would not need to be axially withdrawn from an end of the fitting body during disassembly. Some examples of fittings that provide for substantially zero clearance between a fitting body and tube are illustrated and described in the embodiments of FIGS. 2A-6, 16-21, 29, 38-40, 48A, 48B, 50 and 51.

FIGS. 2A-51 illustrate examples of fittings 10 that may be used with many types of tubing, including thin walled tubing. The following table lists examples of thin walled tube configurations.

TABLE I

| O.D. (inch) | Wall Thickness (inch) |
|---|---|
| 0.250 | Less than 0.028 |
| 0.375 | Less than 0.035 |
| 0.500 | Less than 0.049 |
| 0.750 | Less than 0.065 |
| 1.000 | Less than 0.083 |
| 1.250 | Less than 0.109 |
| 1.500 | Less than 0.134 |
| 2.000 | Less than 0.188 |

While Table I lists examples of different thin walled tubes, the disclosed fittings can be used on tubing of varying wall thicknesses, including wall thicknesses that are greater than or less than the wall thicknesses listed above. A thin walled tube having a diameter greater than 0.250 inches may be defined as any tube having a wall thickness to diameter ratio Tw/D that is less than or equal to 1/10. The tubing can be made from a wide variety of different materials. Examples of possible tubing materials include, but are not limited to, any metal, such as stainless steel, copper, nickel, titanium steel, and aluminum, and any plastic, such as PFA and PTFE. The disclosed fittings may work particularly well with tubes made from soft material.

FIGS. 2A and 2B schematically illustrate an exemplary embodiment of a fitting adapted to provide a narrow ring of engagement between a tube gripping member and a tube. In the illustrated example, the fitting 10 includes a fitting body 14, a nut 16, and a tube gripping member 18. The nut 16 is assembled with the fitting body and has an annular bore 21 that may be sized to receive a tube 12. The annular tube gripping member 18 is assembled between the fitting body 14 and the nut 16. In the example illustrated by FIGS. 2A and 2B, the tube gripping member 18 has an annular tube indenting edge 20 that plastically indents the tubing 12 along a circumferential ring of engagement 22 when the fitting body 14 and the nut 16 are tightened.

In the example illustrated by FIGS. 2A and 2B, the nut 16 includes a cylindrical recess 26 that extends to the annular bore 21. An annular drive surface 28 is defined at the transition from the cylindrical recess 26 to the annular bore 21. Female threads 30 are defined in the cylindrical recess. The exemplary fitting body defines an abutment surface 32 and an annular bore 33. In the illustrated example, the abutment surface 32 acts as a stop for a tube end portion 34 and for the tube gripping member 18. The fitting body 14 includes external threads 35 that mate with the female threads 30 of the nut 16. Relative rotation of the nut 16 with respect to the fitting body 14 causes relative axial movement of the fitting body with respect to the nut 16. In the exemplary embodiment, the fitting body 14 and the nut 16 can be tightened with hand tools, such as wrenches. When the fitting body 14 and the nut 16 are tightened, the nut 16 and the fitting body 14 move relatively toward one another.

A tube indenting edge of a tube gripping member may be configured to provide a focused or narrow ring of engagement with a tube. For example, with reference to the embodiment of FIGS. 2A and 2B, the tube indenting edge 20 may be a sharp edge that reduces the width of the ring of engagement between the tube gripping member and the tube. As a result, the forces required to indent or plastically deform the gripping member 18 are also reduced. In an exemplary embodiment, the sharp annular tube indenting edge 20 may have a width in the range of 0.001 inches to 0.020 inches and may have a radius. This width is the width of the portion of the edge 20 that contacts the tube 12 when the tube indenting edge first engages the tube, prior to any significant indentation of the tube 12.

Further driving or engagement of the annular tube indenting edge 20 into the tube 12 beyond this initial engagement provides a seal and tube grip between the tube gripping member 18 and the tubing 12 by applying force to a narrow, focused ring 44 around the circumference of the tube 12. In an exemplary embodiment, the focused ring of engagement may have a width in a range from 0.010 inches to 0.030 inches. The exemplary tube indenting edge 20 locally applies high stress at the narrow ring 44 of engagement, but the total load applied to the tube is reduces by the narrower ring of engagement. Referring to FIG. 2B, the high stress applied may cause plastic deformation or indentation of the tube to create a seal between the gripping ring 18 and the tube 12. As a result of the reduced load applied by the tube gripping member 18, when the fitting 10 is assembled with a thin walled tube, as one example, the thin walled tube will have sufficient strength to withstand the reduced load applied to the thin walled tube by the sharp annular tube indenting edge 20. In such an embodiment, the inner diameter of the thin walled tubing may be substantially unchanged by engagement of the tube indenting edge.

As another example, the tube indenting edge 20 may additionally or alternatively be hardened, with respect to the tube, other fitting components, or other portions of the tube gripping member 18. A harder indenting edge may keep its shape better while the tube indenting edge plastically deforms the tubing, which may reduce the width of the ring of engagement, as well as reduce the force required to plastically deform the tube. In an exemplary embodiment, the tube indenting edge 20 has a Rockwell hardness scale C hardness between R_{c} 40 and R_{c}, 70. Examples of hardening processes that can be employed include, but are not limited to, case hardening, work hardening, and hardening using a low temperature carburization process. The entire gripping member 18 may be hardened, or only a portion of the gripping member, such as the tube indenting edge 20 may be hardened. One process that can be used to harden the tube indenting edge 20 without hardening the remainder of the gripping member is disclosed in U.S. Pat. No. 6,165,597, entitled “Selective Case Hardening Processes at Low Temperature” to Williams et al., which is incorporated herein by reference in its entirety. The gripping member 18 to be hardened may be made from a nickel alloy, titanium, copper alloys, steel, stainless steel, such as 316 stainless steel, and other metals.

Many configurations or mechanisms may be used to drive a tube gripping member into engagement with a tube to provide a ring of engagement, as described above. In one embodiment, a tool, such as, for example, a clamping or crimping tool, may be used to clamp or tighten a gripping member to a tube prior to fitting installation. In another embodiment, the assembly or pull-up of a fitting on a tube may engage the tube gripping member with the tube. In the example of FIGS. 2A and 2B, the tube indenting edge 20 is driven into the tubing 12 when the fitting 10 is tightened from a loose or finger-tight condition shown in FIG. 2A to a tightened or pulled up condition shown in FIG. 2B. As one example, when the nut 16 and the fitting body 14 move toward one another during tightening of the fitting 10, the annular tube indenting edge 20 may be forced into the tube 12 to plastically deform the tube 12 along ring of engagement and form a seal between the tube 12 and the gripping member 18.

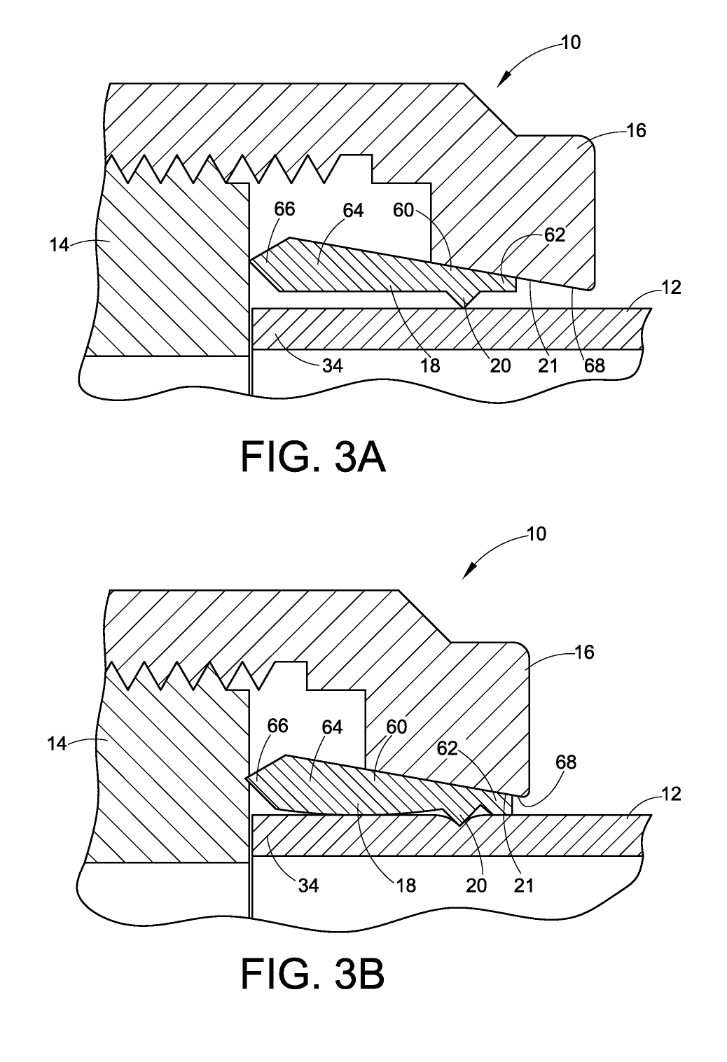

In one such embodiment, a cam structure may be provided to force the tube indenting edge into the tube. For example, a camming portion or surface associated with a fitting component, such as, for example, a fitting body or nut, may engage a corresponding portion or surface on the tube gripping member 18. FIGS. 2A and 2B schematically show, in phantom, a camming portion 38 associated with the nut 16 that engages a corresponding portion 42a on the tube gripping member 18 to drive the tube indenting edge 20 into the tube 12 when the fitting 10 is tightened. FIGS. 2A and 2B also schematically show, as an alternative or additional feature, a camming portion 40 associated with the fitting body 14 that engages a corresponding portion 42b on the tube gripping member 18 to drive the tube indenting edge 20 into the tube 12 when the fitting 10 is tightened. When the cam structure is associated with the nut, the cam structure may be defined by a portion of the nut and/or the cam structure may be defined by a separate member or members that coact with the nut. When the cam structure is associated with the fitting body, the cam structure may be defined by a portion of the fitting body and/or the cam structure may be defined by a separate member or members that coact with the fitting body. More specific examples of cam structures are shown and described in the embodiments of FIGS. 3A, 3B, 5A-8B, 10, 11, 16-19, 29-33, 41-43, 46, 47, 50, and 51.

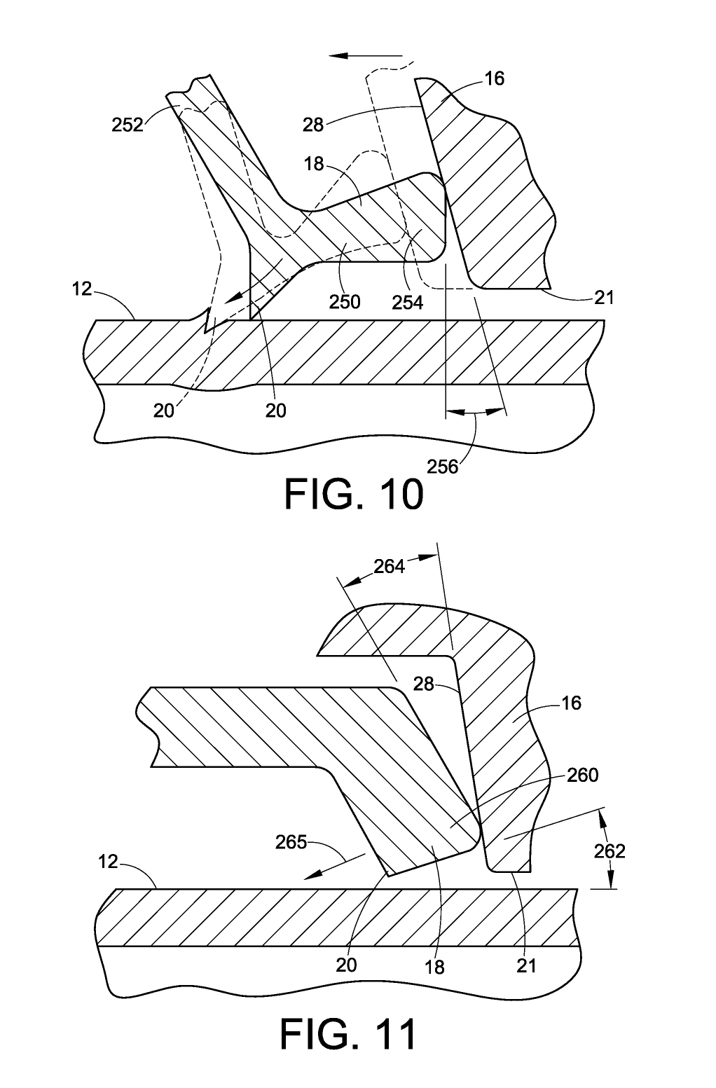

In the exemplary embodiment of FIGS. 2A and 2B, the cam structure drives the tube indenting edge 20 substantially directly radially into the tube. However, in other embodiments, an indenting edge may be driven into the tube at some other angle, as shown and described, for example, in the embodiments of FIGS. 10, 11, and 18.

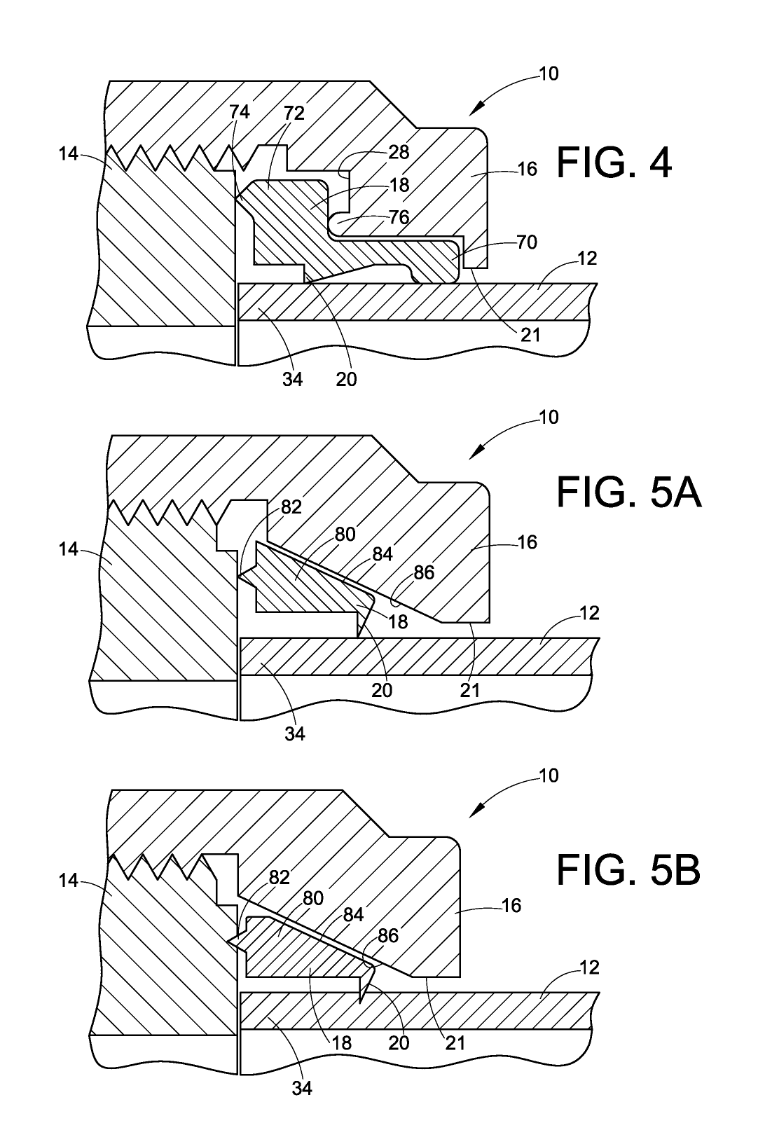

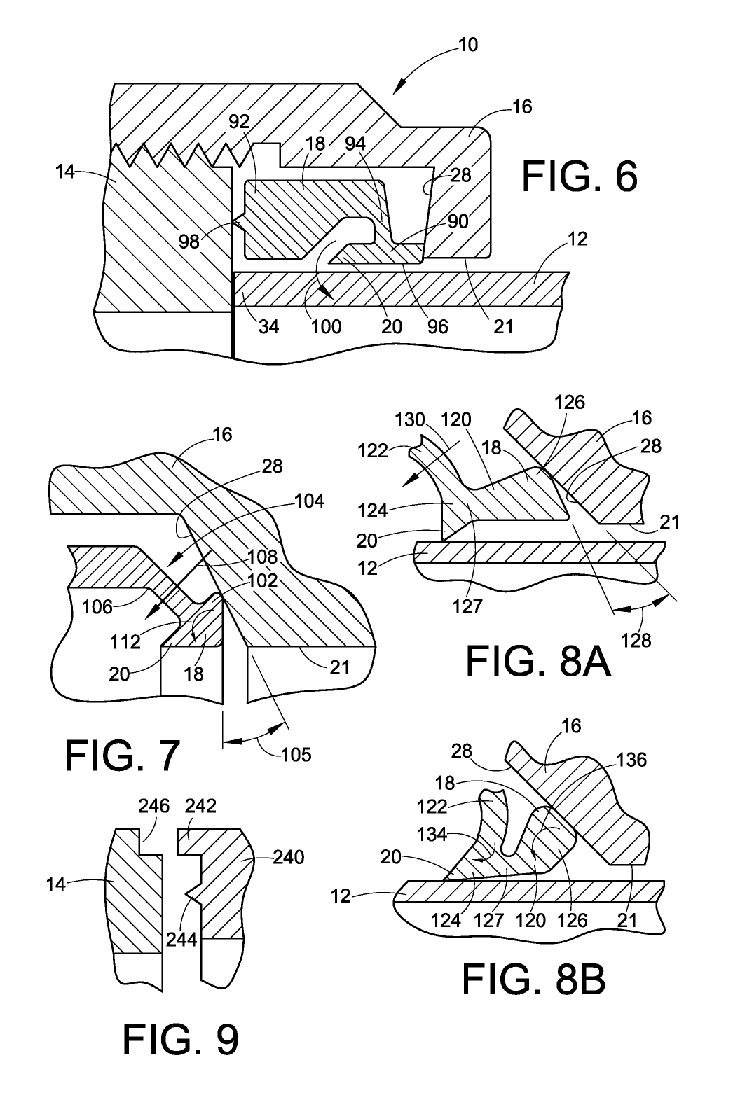

Other mechanisms for driving a tube gripping member into engagement with a tube may be provided instead of, or in addition to, a cam structure as described above. Examples of these mechanisms include, pivoting tube gripping members, as shown, for example, in FIGS. 4 and 12-16, flexing tube gripping members, as shown, for example, in FIGS. 6-8B and 10, and force transferring or colleting members, as shown, for example, in FIGS. 15, 18, 29 and 41-43.

Referring to FIGS. 2A and 2B, the gripping ring 18 may be permanently secured to the tube 12 when the nut 16 and fitting body are tightened or pulled-up. The nut 16 may be removed from the fitting body 14 and the tube end 34 and secured gripping ring 18 may be separated from the fitting body 14 to break the coupling. In such an embodiment, the seal between the tube gripping member 18 and the tubing 12 may remain intact when the fitting body 14 and the nut 16 are disassembled. The coupling may be remade by tightening the nut 16 to the fitting body 14. The fitting body 14 and the nut 16 may be assembled, disassembled, and reassembled, or otherwise adjusted, with hand tools. In one embodiment, the tube gripping member 18 and the tubing 12 can be separated from the fitting body 14 without substantial axial movement of the tubing with respect to the fitting body when the fitting body and the nut are disassembled. That is, substantially zero axial clearance is required to make and break the coupling in this embodiment.

According to another aspect of the present application, a fitting may be provided with a sealing structure to provide a seal between a fitting body and a tube gripping member. Many different types of sealing structures may be used. In the exemplary embodiment of FIGS. 2A and 2B, a sealing structure, schematically shown at 46, provides a seal between the tube gripping member 18 and the fitting body 14. The sealing structure 46 may be defined by the fitting body 14, the tube gripping member 18, or one or more components positioned between the fitting body 14 and the tube gripping member 18. More specific examples of sealing structures are shown and described in the embodiments of FIGS. 3A-6, 9, 13, 16-24, 27-29, 36-43, 46, 48A, 48B, 50, and 51.

As one example of a sealing structure, a tube gripping member may be provided with a portion adapted to engage a surface of the fitting body to create a seal. In the example illustrated by FIGS. 3A and 3B, the gripping member comprises a sleeve 60 having a fitting body sealing portion 64. The annular tube indenting edge 20 extends radially inward from the sleeve 60. While the body sealing portion may include many different types of sealing structures, the illustrated fitting body sealing portion 64 includes an annular body indenting edge 66 that provides a seal between the fitting body and the gripping member. As with the tube indenting edge 20 discussed above, the body indenting edge may also be a sharp or hardened edge to reduce the forces required to create a seal between the tube gripping member 18 and the fitting body 14.

As with the tube indenting edge 20 discussed above, many different mechanisms or configurations may be utilized to drive a body indenting edge of a tube gripping member into a fitting body during assembly of the fitting. In one embodiment, a cam surface may be provided on one of the fitting components that directly or indirectly coacts with the tube gripping member to drive the body indenting edge toward the fitting body when the fitting is tightened. In another embodiment, one cam surface may drive both a tube indenting edge of a tube gripping member into engagement with a tube, and a body sealing portion of a tube gripping member into engagement with the fitting body. In one such embodiment, the cam surface is provided on a fitting nut. In the exemplary embodiment of FIGS. 3A and 3B, the annular bore 21 through the nut 16 is frustoconical to define a camming surface 68. When the nut 16 and the fitting body 14 are tightened, the camming surface 68 engages the gripping member 18 and forces the tube indenting edge 20 into engagement with the tube and forces the annular body indenting edge 66 into engagement with fitting body 14. The tube indenting edge 20 plastically deforms the tubing around a focused, localized, or narrow ring of engagement to provide a seal between the gripping member 18 and the tube 12. The edge 66 is driven into the fitting body 14, plastically deforming the fitting body to provide a seal between the fitting body 14 and the tube gripping ring 18.

According to another aspect of the present application, a tube gripping member or other fitting component may be provided with a damping portion that engages the tubing upon tightening of the fitting to inhibit or reduce vibration within the end of the tubing that is assembled with the fitting, which may assist in maintaining seals within the fitting, such as, for example, a seal between a tube gripping member and a tube fitting. In the illustrated embodiment of FIGS. 3A and 3B, the tube gripping member 18 is provided with a damping portion 62 that engages the tube 12 to inhibit vibration of the tube from being transferred to the junction of the tube indenting edge 20 and the tube 12. Other examples of damping portions on tube gripping members or other components are shown and described in the embodiments of FIGS. 4, 7, 18, 34, and 47.

According to another aspect of the present application, a fitting may be configured such that the tubing, tube gripping member, and/or other internal fitting components do not extend substantially beyond an end face or end surface of the fitting body. As such, the tubing may be assembled with and/or separated from the fitting body with substantially zero clearance, or without substantial axial movement of the tubing with respect to the fitting body. In the example illustrated by FIGS. 3A and 3B, the body indenting portion 66 of the tube gripping member 18 seals against an end surface of the fitting body 14, and the tubing 12 does not extend into or over the end of the fitting body 14. As such, substantially zero clearance may be achieved in assembling the tubing with the fitting 10 or separating the tubing from the fitting body 14. As the indentation of the body indenting edge 66 of the tube gripping member 18 into the body 14 is relatively small, axial movement of the tubing and tube gripping member during removal of the tube gripping member from the indentation during tubing separation may be considered insubstantial axial movement.

In the example illustrated by FIGS. 5A and 5B, the gripping member 18 comprises a sleeve 80 having a fitting body indenting edge 82. The sleeve 80 may have a frustoconical outer surface 84. The annular tube indenting edge 20 extends radially inward from the sleeve 80. The annular bore 21 through the nut 16 is frustoconical to define a caroming surface 86. When the nut 16 and the fitting body 14 are tightened, the caroming surface 86 engages the frustoconical outer surface 84 and forces the tube indenting edge 20 into engagement with the tube and forces the annular body indenting edge 82 into engagement with fitting body 14. The tube indenting edge 20 plastically deforms the tubing to provide a seal between the gripping member 18 and the tube 12. The edge 82 cuts into the fitting body 14 to provide a seal between the fitting body 14 and the tube gripping ring 18. In the example illustrated by FIGS. 5A and 5B, the tube gripping member 18 and the tubing 12 can be separated from the fitting body 14 without substantial axial movement of the tubing with respect to the fitting body when the fitting body and the nut are disassembled.

In one embodiment, an indenting edge of a tube gripping member may be rotated or pivoted into engagement with a tube when the fitting is tightened. In one such embodiment, a hinge portion of the tube gripping member may engage another fitting component, such as a fitting body. When additional force is applied between the tube gripping member and the fitting body, the tube gripping member pivots about the hinge portion, causing the tube indenting edge to engage the tube. In the example of FIG. 4, an annular tube indenting edge 20 of a tube gripping member 18 is non-perpendicular with respect to the tubing 12. That is, the edge 20 is not directed entirely radially into the tube prior to a tightening engagement. A fitting body sealing portion 72 of the tube gripping member 18 projects axially toward an end surface of the fitting body 14. The fitting body sealing portion 72 includes a sharp annular body indenting edge 74. The nut 16 includes a gripping member engaging projection 76 that extends axially from the drive surface 28. When the nut 16 and the fitting body 14 are tightened, the projection 76 contacts the gripping member 18 between the tube indenting edge 20 and the body indenting edge 74 and forces the annular body indenting edge 74 into engagement with fitting body 14. The tube gripping member 18 rotates or pivots about the body indenting edge 74 and the tube indenting edge 20 is driven into engagement with the tube 12. The tube indenting edge 20 plastically deforms the tubing to provide a seal between the gripping member 18 and the tube 12. The edge 74 cuts into the fitting body 14 to provide a seal between the fitting body 14 and the tube gripping member 18. The damping portion 70 engages the tube 12 to inhibit vibration of the tube from being transferred to the junction of the gripping member 18 and the tube 12. In the example illustrated by FIG. 4, substantially zero axial clearance is required to make and break the coupling.

In addition to pivoting of the tube gripping member, other types of deformation of the tube gripping member may be utilized to drive a tube indenting edge on the gripping member into engagement with a tube when the fitting is tightened. For example, in one embodiment, a thinner portion or web of a tube gripping member flexes when the fitting is tightened, thereby driving the tube indenting edge into engagement with the tube. This web portion may, but need not, be made more flexible by preserving an unhardened condition of the web portion; for example, by hardening the tube indenting edge and/or other portions of the tube gripping member, such as with a low temperature carburization process, while not hardening the web portion. FIGS. 6, 7, 8A, 8B, and 10 illustrate exemplary embodiments of fittings 10 that are configured such that the annular tube indenting edge 20 pivots or rotates as it engages the tubing, as a result of flexing of the tube gripping member.

In the example illustrated by FIG. 6, the tube gripping member 18 includes a tube gripping portion 90, a fitting sealing portion 92, and a thin web 94 that connects the tube gripping portion 90 to the sealing portion 92. In one embodiment, the gripping portion 90 and the sealing portion 92 are hardened and the web 94 is not hardened to allow the web to flex. The tube gripping portion 90 has an annular inner surface 96 that is generally parallel to the tube before the nut 16 and the fitting body 14 are tightened. The sealing portion 92 includes a sealing projection 98. When the nut 16 and the fitting body 14 are tightened, the sealing projection 98 is forced into sealing engagement with the fitting body 14. An angled drive surface 28 on the nut 16 causes the web 94 flexes and the tube gripping portion 20 to rotate as indicated by arrow 100 such that the tube indenting edge 20 is driven into engagement with the tube 12. The tube indenting edge 20 plastically deforms the tubing 12 to provide a seal between the gripping member 18 and the tube 12. In the example illustrated by FIG. 6, substantially zero axial clearance is required to make and break the coupling.

FIG. 7 illustrates an example of a tube gripping member 18 that includes a tube gripping portion 102 that is supported by a slanted web 104. An angular gap 105 is defined by a difference angle between the gripping portion 102 and the drive surface 28 of the nut 16. When the nut 16 and the fitting body 14 are tightened, the web 104 flexes at region 106 as indicated by arrow 108. The slanted web 104 applies a radial compression force to the annular tube indenting edge 20 during pull-up or tightening of the nut 16. The gripping ring has a hinging action and plastically deforms during pull-up to embed the edge 20 into the tube wall for enhanced tube grip, and an axially adjacent collet zone 103. The collet zone 103 protects the indentation from vibration by damping vibration in the tubing. The angular gap 105 allows for radially inward toroidal rotation of the tube gripping portion 102 as indicated by arrow 112. The tube indenting edge 20 plastically deforms the tubing 12 to provide a seal between the gripping member 18 and the tube 12. In one embodiment, the gripping portion 102 is hardened and the web 104 is not hardened to allow the web to flex.

FIGS. 8A and 8B illustrate an example of a tube gripping member 18 that includes a tube gripping portion 120 that is supported by a slanted web 122. The gripping portion 120 includes a tube engagement portion 124, a nut engagement portion 126, and a transition portion 127 having a reduced thickness that connects the tube engagement portion and the nut engagement portion. In the example illustrated by FIGS. 8A and 8B, the tube engagement portion is positioned to slightly interfere with the tube during insertion. An angular gap 128 is defined by a difference angle between the nut engagement portion 126 and the drive surface 28 of the nut 16. As shown in FIG. 8B, when the nut 16 and the fitting body 14 are tightened, the web 122 flexes as indicated by arrow 130, the tube engagement portion 124 rotates in the direction indicated by arrow 134, and the nut engagement portion rotates in the direction indicated by arrow 136. The transition portion 127 flexes to allow the rotation of the nut engagement portion 126 and the tube engagement portion in different directions. The slanted web 122 applies a radial compression force to the annular tube indenting edge 20 during pull-up. The tube indenting edge 20 plastically deforms the tubing 12 to provide a seal between the gripping member 18 and the tube 12. In one embodiment, the tube engagement portion 124 and the nut engagement portion 126 are hardened and the transition portion 127 is not hardened to allow the transition portion to flex.

FIG. 10 illustrates an example of a tube gripping member 18 that includes a tube gripping portion 250 that is supported by a slanted web 252. The gripping portion 250 includes a nut engagement portion 254 and the annular tube indenting edge 20. An angular gap 256 is defined by a difference angle between the nut engagement portion 254 and the drive surface 28 of the nut 16. When the nut 16 and the fitting body 14 are tightened, the web 252 flexes. The slanted web 252 applies a radial compression force to the annular tube indenting edge 20 during pull-up. The angular gap 256 allows the nut engagement portion 254 to move radially outward and rotate the tube indenting edge 20 into the tubing. The tube indenting edge 20 plastically deforms the tubing 12 to provide a seal between the gripping member 18 and the tube 12. In one embodiment, the tube gripping portion 250 and the nut engagement portion 254 are hardened and the web 252 is not hardened to allow the web to flex.

FIG. 11 illustrates an example of a tube gripping member 18 with a tube engagement portion 260 that is positioned at an angle 262 with respect to the tube 12 before the fitting is pulled up. An angular gap 264 is defined by a difference angle between the tube engagement portion 260 and the drive surface 28 of the nut 16. When the nut 16 and the fitting body 14 are tightened, the tube engagement portion 260 moves in the direction indicated by arrow 265. The tube indenting edge 20 plastically deforms the tubing 12 to provide a seal between the gripping member 18 and the tube 12. The angular gap 264 allows the tube gripping member to pivot upon engagement of the tube indenting edge 20 with the tube 12, thereby providing a greater localized gripping force.

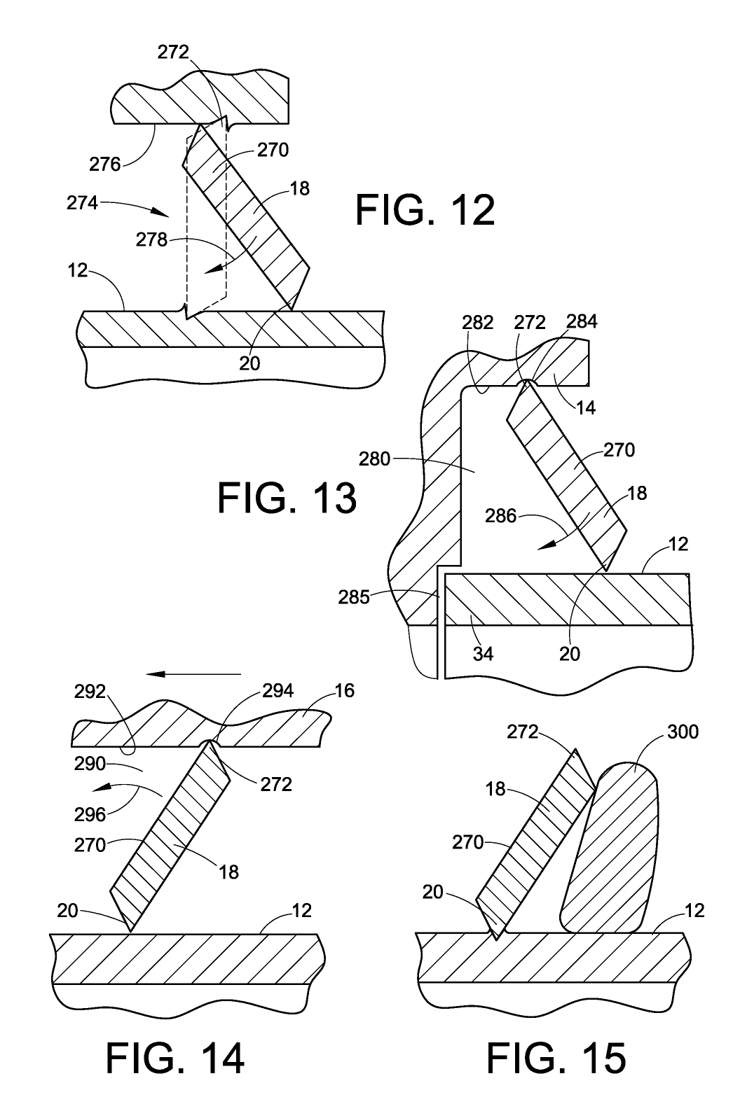

In other embodiments, the tube gripping member may include a spring washer, such as a Belleville washer. FIGS. 12-17 illustrate examples of fittings where the tube gripping member comprises a spring washer 270. The spring washer 270 includes a radially outer annular body indenting edge 272, that may be adapted to engage a surface of the fitting body 14 upon tightening the fitting. The annular tube indenting edge 20 in the examples of FIGS. 12-17 is a radially inner annular edge of the spring washer. In one embodiment, the spring washer is hardened. Additionally, the fitting body 14 may be made from a softer material, such as 316 stainless steel, to allow the spring washer 270 to plastically deform the fitting body 14 when the fitting is tightened.

In the example of FIG. 12, the fitting body 14 includes a spring washer receiving bore 274 that defines an annular interior surface 276. The body indenting edge 272 is initially radially spaced apart from 12. When the fitting is pulled up, the outer body indenting edge 272 engages and bites into the interior surface 276 of the fitting body to provide a seal between the spring washer and the fitting body 14. The spring washer 270 rotates about the body indenting edge 272 as indicated by arrow 278 to bring the tube indenting edge 20 into engagement with the tube. The tube indenting edge 20 plastically deforms the tube 12 to provide a seal between the spring washer 270 and the tube.

In one embodiment, a groove or other such recess may be provided in a fitting bore for receiving an edge of a tube gripping member. This recess may hold the edge of the tube gripping member during tightening of the fitting, providing a seal between the tube gripping member and the receiving bore, and/or allowing the tube gripping member to pivot about the edge to drive a tube indenting edge into the tube. In the example of FIG. 13, the fitting body 14 includes a spring washer receiving bore 280 that defines an annular interior surface 282. An annular indenting edge receiving recess 284 extends radially outward from the interior surface 282. The fitting body 14 includes an annular recess 285 that accepts an end 34 of the tube. The body indenting edge 272 is positioned in the indenting edge receiving recess 284. When the fitting is pulled up, the outer body indenting edge 272 bites into the recess 284 to provide a seal between the spring washer and the fitting body 14. The spring washer 270 rotates about the body indenting edge 272 as indicated by arrow 286 to bring the tube indenting edge 20 into engagement with the tube. The tube indenting edge 20 plastically deforms the tube 12 to provide a seal between the spring washer 270 and the tube.

In the example of FIG. 14, the nut 16 includes a spring washer receiving bore 290 that defines an annular interior surface 292. An annular indenting edge receiving recess 294 extends radially outward from the interior surface 292. The nut indenting edge 272 is positioned in the indenting edge receiving recess 294. When the fitting is pulled up, the tube indenting edge 20 plastically deforms the tube 12. The spring washer 270 rotates about the tube indenting edge 20 as indicated by arrow 296 to bring the nut indenting edge 272 into engagement with the nut 16. The spring washer 270 seals with the tube 12 and the nut 16.

In one embodiment, an additional fitting component may be provided to transfer axial force from a first fitting component, such as a nut, to a tube gripping device. Many different types of components may be used for transferring the axial force, such as, for example, a collet, ferrule, or gasket. In the example of FIG. 15, the fitting 10 includes a collet 300 that transfers axial force from the nut 16 to the spring washer 270. The tube indenting edge 20 is pressed into engagement with the tube and the body indenting edge 272 is pressed into engagement with the fitting body or a sealing structure. The tube indenting edge 20 plastically deforms the tube 12 to provide a seal between the spring washer and the tube.

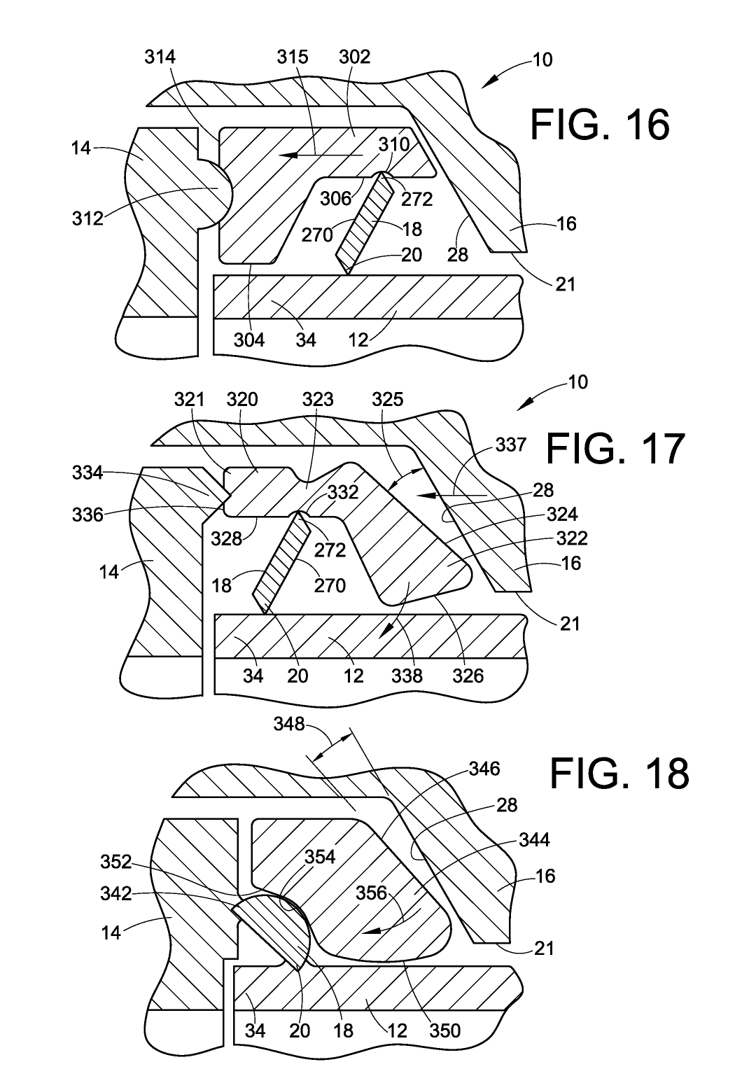

In providing a seal between a fitting body and a tube gripping member, a portion of the gripping member may seal directly against a portion of the fitting body, as shown, for example, in the embodiments of FIGS. 4, 6, and 13. In another embodiment, an intermediary sealing component may provide a seal between the fitting body and the tube gripping member. In the example illustrated by FIG. 16 a sealing or gland member 302 is positioned between the fitting body 14 and the nut 16. The illustrated sealing member 302 is generally cylindrical. A tube bore 304 and a spring washer receiving bore 306 are defined through the gland member. The tube bore 304 is sized to accept the tube 12. An annular indenting edge receiving recess 310 extends radially outward from the spring washer bore 306. The fitting body 14 includes an annular sealing protrusion 312 that seals against an end face 314 of the sealing member 302 when the fitting 10 is pulled up. The gland indenting edge 272 is positioned in the indenting edge receiving recess 310. When the fitting is pulled up, the tube indenting edge 20 plastically deforms the tube 12. The sealing member 302 is compressed to form the seal with the fitting body 14 and axially moves the outer gland indenting edge 272 as indicated by arrow 315. The spring washer 270 rotates about the tube indenting edge 20 to bring the gland indenting edge 272 into engagement with the sealing member 302. The gland indenting edge 272 bites into the recess 310 to provide a seal between the spring washer and the sealing member 302. In the example illustrated by FIG. 16, the sealing member can be configured such that the tube gripping member 18 and the tubing 12 can be separated from the fitting body 14 without substantial axial movement of the tubing with respect to the fitting body when the fitting body and the nut are disassembled.

In the example illustrated by FIG. 17, a sealing or gland member 320 is positioned between the fitting body 14 and the nut 16. The sealing member 320 includes a body engaging portion 321, a colleting portion 322, and an area of reduced thickness or web 323 that connects the body engaging portion and the colleting portion. The colleting portion 322 includes an angled outer surface 324. An angular gap 325 is defined by a difference angle between the outer surface 324 of the colleting portion and the drive surface 28 of the nut 16. A tube bore 326 and a spring washer receiving bore 328 are defined through the gland member. The tube bore 326 is sized to accept the tube 12. An annular indenting edge receiving recess 332 extends radially outward from the tube bore 326. The fitting body 14 includes a sharp annular sealing protrusion 334 that seals against an end face 336 of the sealing member 320 when the fitting 10 is pulled up. The gland indenting edge 272 is positioned in the indenting edge receiving recess 332. When the fitting is pulled up, the tube indenting edge 20 plastically deforms the tube 12. The sealing member 320 is compressed to form the seal with the fitting body 14 and to axially move the gland indenting edge 272 as indicated by arrow 337. The spring washer 270 rotates about the tube indenting edge 20 to bring the gland indenting edge 272 into engagement with the sealing member 320. The gland indenting edge 272 bites into the recess 332 to provide a seal between the spring washer and the sealing member 320. The area of reduced thickness 323 flexes during pull up. The colleting portion 322 rotates as indicated by arrow 338 into engagement with the tube. The colleting portion inhibits vibration of the tube from being communicated to the interface of the tube indenting edge 20 and the tube. In the example illustrated by FIG. 17, the tube gripping member 18 and the tubing 12 can be separated from the fitting body 14 without substantial axial movement of the tubing with respect to the fitting body when the fitting body and the nut are disassembled.

As another example of a type of tube gripping member that may be used, FIG. 18 illustrates a fitting where the tube gripping member 18 is generally toroidal. The toroidal tube gripping member includes an annular fitting body indenting edge 342 and an annular tube indenting edge 20. In one embodiment, the tube gripping member 18 is hardened. In the example illustrated by FIG. 18, a colleting member 344 is positioned between the gripping member 18 and the nut 16. The colleting member 344 includes an angled outer surface 346. An angular gap 348 is defined by a difference angle between the outer surface 346 and the drive surface 28 of the nut 16. A tube bore 350 and a toroidal gripping member recess 352 are defined through the colleting member 346. The tube bore 350 is sized to accept the tube 12. The gripping member recess 352 defines a gripping member drive surface 354. The fitting body indenting edge 342 is driven into an end face of the fitting body to provide a seal between the fitting body 14 and the tube gripping member 18 when the fitting 10 is pulled up. When the fitting is pulled up, the tube indenting edge 20 plastically deforms the tube 12 to provide a seal between the gripping member and the tube. The colleting member 344 rotates as indicated by arrow 356 into engagement with the tube. The colleting portion inhibits vibration of the tube 12 from being communicated to the interface of the tube indenting edge 20 and the tube 12.

According to another aspect of the present invention, one or more fitting components may be provided with alignment features to properly align one or more fitting components during assembly of the fitting. In one embodiment, an alignment projection on a first fitting component may engage an alignment recess on a second fitting component to properly align the first and second fitting components. As one example, FIG. 9 illustrates a sealing portion 240 that includes an annular alignment projection 242 and an annular sealing projection 244. The sealing portion 240 may be formed integrally with the gripping member or may form part of a separate sealing member. The fitting body 14 includes an annular alignment recess 246. The alignment projection 242 and the alignment recess co-act to align the gripping member 18 and the fitting body during pull-up of the fitting 10. In one embodiment, the recess is included on the gripping member 18 and the projection is included on the fitting body. When the nut 16 and the fitting body 14 are tightened, the sealing projection 244 is forced into engagement with fitting body 14 to provide a seal between the sealing portion 240 and the fitting body 14.

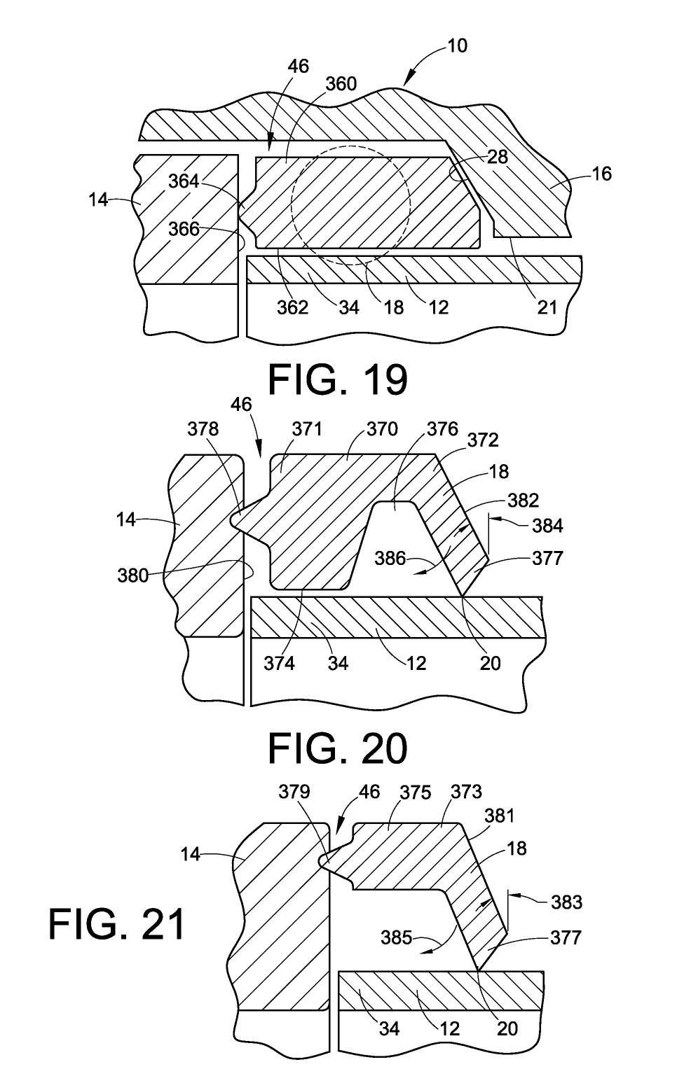

FIGS. 19-24 illustrate additional examples of fittings 10 that include a sealing structure 46 that provides a seal between the fitting body 14 and the gripping member 18. The sealing structures illustrated by FIGS. 19-24 allow the tube gripping member 18 and the tubing 12 to be separated from the fitting body 14 with minimal or no axial movement of the tubing with respect to the fitting body when the fitting body and the nut are disassembled. In the example illustrated by FIG. 19, the sealing structure 46 comprises a sealing or gland member 360 positioned between the fitting body 14 and the nut 16. FIG. 19 schematically illustrates that any gripping member 18 may be associated with the sealing member 360 such that a seal is formed between the gripping member and the sealing member or that the gripping member may be formed as part of the sealing member 360. The illustrated sealing member 360 is generally cylindrical. A tube bore 362 is defined through the sealing member 360. The tube bore 362 is sized to accept the tube 12. The sealing member 360 includes an annular sealing protrusion 364 that seals against an end face 366 of the fitting body when the fitting 10 is pulled up.

In the example illustrated by FIG. 20, the sealing structure 46 comprises a sealing or gland member 370 that includes a sealing portion 371 and an integral tube gripping portion 372. The illustrated sealing member 370 is generally cylindrical. A tube bore 374 is defined through the sealing member 370. An annular recess 376 extends radially outward from the tube bore 374 between the sealing portion 371 and the tube gripping portion 372. The annular recess 376 allows the tube gripping portion 372 to flex with respect to the sealing portion. The sealing portion 371 includes an annular sealing protrusion 378 that seals against an end face 380 of the fitting body when the fitting 10 is pulled up. The tube gripping portion 372 includes an inclined nut engagement surface 382. An angular gap 384 is defined by a difference angle between the nut engagement surface 382 and the drive surface of the nut (not shown). The drive surface may be perpendicular to the tube 12, as suggested by the angular gap 384, or it may be provided at some other angle. When the fitting is pulled up, the tube gripping portion is flexed in the direction indicated by arrow 386 and the tube indenting edge 20 plastically deforms the tubing 12 to provide a seal between the gripping portion 372 and the tube 12.

In the example illustrated by FIG. 21, the sealing structure 46 comprises a sealing or gland member 373 that includes a sealing portion 375 and an integral tube gripping portion 377. The illustrated sealing member 373 is generally cylindrical. The sealing portion 375 includes an annular sealing protrusion 379 that seals against an end face of the fitting body when the fitting 10 is pulled up. The tube gripping portion 377 includes an inclined nut engagement surface 381. An angular gap 383 is defined by a difference angle between the nut engagement surface 383 and the drive surface of the nut (not shown). The drive surface may be perpendicular to the tube 12, as suggested by the angular gap 383, or it may be provided at some other angle. When the fitting is pulled up, the tube gripping portion is flexed in the direction indicated by arrow 385 and the tube indenting edge 20 plastically deforms the tubing 12 to provide a seal between the gripping portion 377 and the tube 12.

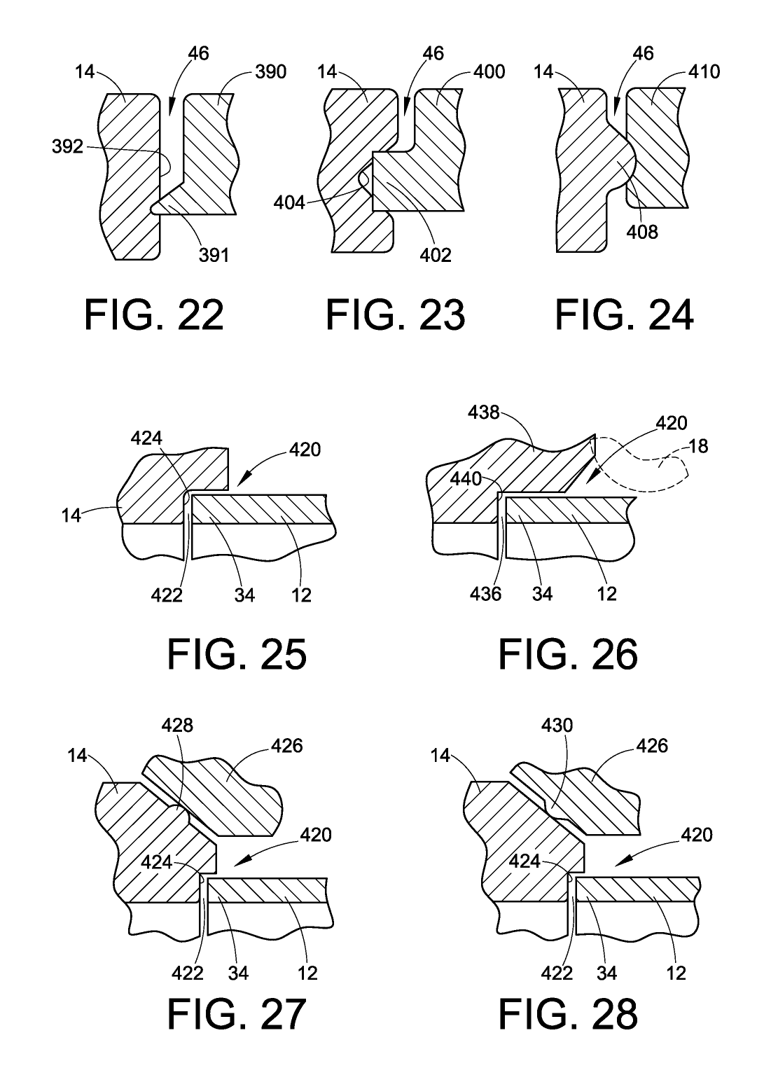

A sealing structure associated with one or more fitting components may comprise many different shapes or configurations. For example, the sealing structure may include features on a surface of a fitting body, features on a surface of a sealing member, or corresponding features on both fitting body and sealing member. FIGS. 22-24 illustrate examples of sealing structures 46. In the example of FIG. 22, sealing structure 46 comprises a sealing or gland member 390 that includes an annular sealing protrusion 391 that engages and cuts into an end face 392 of the fitting body 14. In the example illustrated by FIG. 23, the sealing structure 46 comprises a sealing or gland member 400 that includes an annular sealing protrusion 402 and a fitting body 14 that includes an annular recess 404. When the fitting body is pulled up, the sealing member protrusion 402 seats in the annular recess 404 to provide a seal between the fitting body 14 and the sealing member 390. In the example of FIG. 23, the sealing member protrusion 402 and the annular recess 404 are differently shaped to increase the interference between the protrusion and the fitting body 14 during pull up. In the example of FIG. 24, sealing structure 46 comprises an annular sealing protrusion 408 that extends from the fitting body 14 and engages a sealing or gland member 410. The sealing protrusion 408 deforms the sealing member 410 to provide a seal between the fitting body and the sealing member during pull up.

In one aspect of the present application, a fitting component may be provided with a tube alignment structure adapted to axially align a tube inserted into a fitting. Many different structures may be used, such as, for example, a shoulder or recess on the fitting body that receives an end of the tube in an aligned condition. This alignment of the tube end may serve to limit the insertion depth of the tube into the fitting body. FIGS. 25-28 illustrate examples of tube alignment structures 420 that axially align tube 12 inserted into a fitting 10. In the examples illustrated by FIGS. 25, 27, and 28, the tube alignment structure 420 comprises an annular recess 422. The recess 422 forms a shoulder 424 on the fitting body. The recess 422 is sized to accept the tube 12. When the tube is inserted into the fitting, the recess 422 aligns the tube with the fitting body. The shoulder 424 limits the insertion depth of the tube. In the examples illustrated by FIGS. 27 and 28, an annular sealing member 426 provides a seal between the tube gripping member and the fitting body 14. In the example illustrated by FIG. 27, the fitting body includes an annular sealing protrusion 428 that seals against the sealing member 426. In the example of FIG. 28, the sealing member 426 includes a sealing protrusion 430 that seals against the fitting body 14.

In the example illustrated by FIG. 26, the tube alignment structure 420 comprises an annular recess 436 formed in an annular gasket member 438 that is disposed in the fitting. The recess 436 forms shoulder 440 of the gasket member 438. The recess 436 is sized to accept the tube 12. When the tube is inserted into the fitting, the recess 436 aligns the tube with the fitting body. The shoulder 440 limits the insertion depth of the tube. The annular gasket member 438 may also engage a tube gripping member 18 (represented schematically in FIG. 26) to drive the tube gripping member 18 into engagement with the tube 12 when the fitting is tightened.

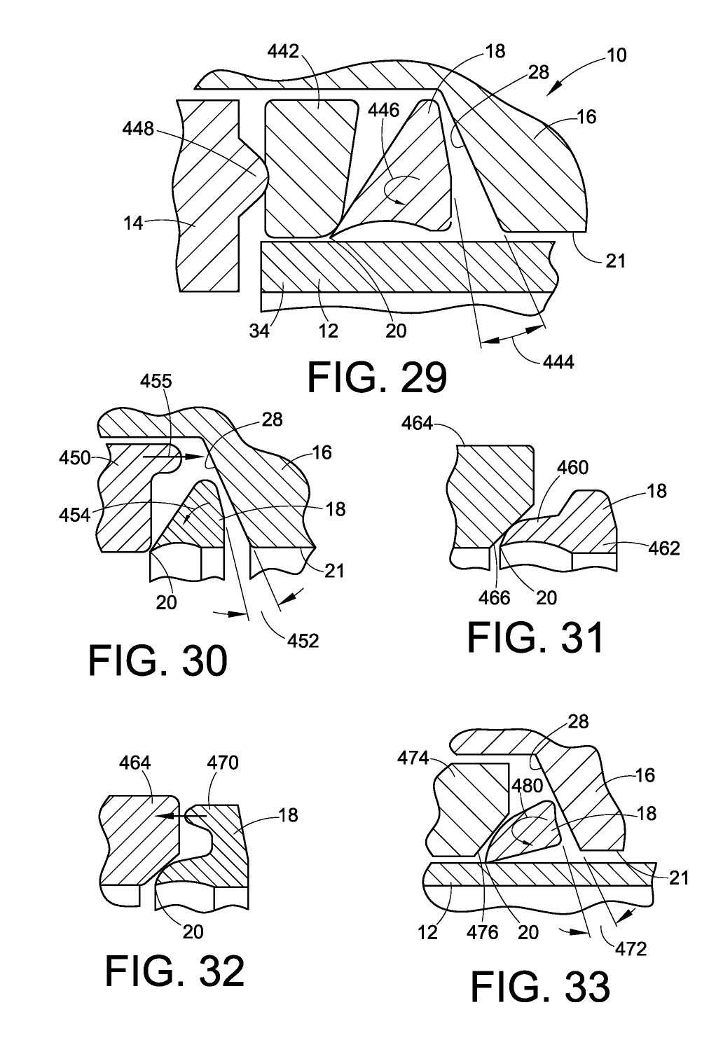

FIGS. 29-34 illustrate examples of fittings having a tube gripping member that coacts with a nut and a sealing member to pivot, cam, or flex into engagement with a tube during fitting assembly. In the example illustrated by FIG. 29, the fitting includes a nut 16, a fitting body 14, a tube gripping member 18, and a sealing member 442. An angular gap 444 is defined by a difference angle 444 between the gripping member 18 and the drive surface 28 of the nut 16. The angular gap 444 allows for rotation of the tube gripping member 18 as indicated by arrow 446 when the fitting is pulled up. The tube indenting edge 20 plastically deforms the tubing 12 at a narrow ring of engagement to provide a seal between the gripping member 18 and the tube 12 when the fitting is pulled up. The gripping member 18 engages and seals against the sealing member 442 when the fitting is pulled up. The sealing member is forced into engagement with fitting body 14 by the gripping member 18. In the embodiment illustrated by FIG. 29, the fitting body 14 includes an annular sealing protrusion 448. The sealing member 442 seals against the protrusion 448 when the fitting 10 is pulled up. In the example illustrated by FIG. 29, the fitting can be disassembled with substantial zero axial movement of the tubing with respect to the fitting body.

In another embodiment in which a tube gripping member coacts with a nut and a sealing member to rotate or pivot into engagement with a tube, a sealing member may be adapted to seal against the nut when the fitting is tightened. Many different sealing arrangements may be used. In the example illustrated by FIG. 30, the fitting includes a nut 16, a fitting body, a tube gripping member 18, and a sealing member 450. The sealing member 450 includes an annular nut sealing protrusion 455 that seals against a drive surface 28 of the nut 16 when the fitting is pulled up. An angular gap 452 is defined by a difference angle between the gripping member 18 and the drive surface 28 of the nut 16. The angular gap 452 allows for rotation of the tube gripping member 18 as indicated by arrow 454 when the fitting is pulled up. The tube indenting edge 20 plastically deforms the tubing 12 to provide a seal between the gripping member 18 and the tube (not shown) when the fitting is pulled up. The gripping member 18 seals against the sealing member 450 and/or the nut 16 when the fitting is pulled up.

A sealing member of a fitting may also be provided with a camming surface for driving a tube gripping member into engagement with a tube when the fitting is tightened. In the example illustrated by FIG. 31, a tube gripping member 18 includes an annular tube gripping portion 460 and an annular nut engagement portion 462. The tube gripping portion 460 is elongated and relatively narrow to permit deflection. A sealing member 464 includes an annular camming surface 466. When the fitting is pulled up, the tube gripping portion 460 is deflected by the camming surface 466 into engagement with the tube (not shown). The tube indenting edge 20 plastically deforms the tubing to provide a seal between the gripping member 18 and the tube when the fitting is pulled up.

The tube gripping member 18 illustrated by FIG. 32 functions in a similar manner as the tube gripping member illustrated by FIG. 31. In the embodiment illustrated by FIG. 32, the gripping member 18 includes an annular sealing protrusion 470 that seals against the sealing member 464 when the fitting is pulled up.

In the example illustrated by FIG. 33, an angular gap 472 is defined by a difference angle between the gripping member 18 and the drive surface 28 of the nut 16. A sealing member 474 includes an annular camming surface 476. The camming surface 476 and the angular gap 472 direct the gripping member 18 as indicated by arrow 480 when the fitting is pulled up. The tube indenting edge 20 plastically deforms the tubing 12 to provide a seal between the gripping member 18 and the tube 12 when the fitting is pulled up. The gripping member 18 engages and seals against the sealing member 474 when the fitting is pulled up.

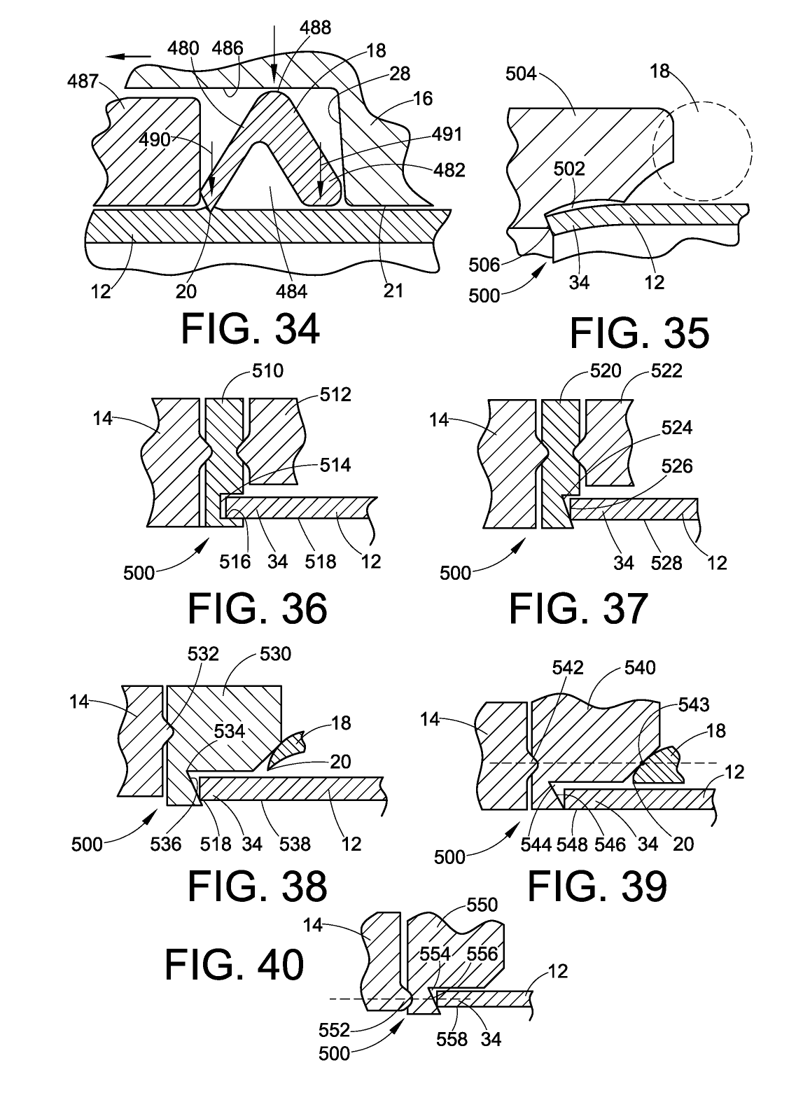

In one embodiment, a tube gripping member may be provided with a nut engaging portion and a tube gripping portion. The tube gripping member may be adapted to flex, such that a force applied by the nut to the nut engaging portion causes the tube gripping portion to flex into engagement with the tube. Many different shapes or configurations may be used to cause the tube gripping member to flex in this fashion. In the example illustrated by FIG. 34, the tube gripping member 18 includes an annular tube gripping portion 480 and an annular nut engagement portion 482. An annular recess 484 is defined between the tube gripping portion 480 and the annular nut engagement portion 482 to allow the tube gripping portion 480 and the nut engagement portion 482 to flex toward one another. The nut 16 includes an annular interior surface 486. When the fitting is pulled up, the tube gripping portion 480 engages a gasket member 487 and the nut engagement portion 482 engages the nut drive surface 28. A radially outer surface 488 of the tube gripping member engages the interior nut surface 486. As the tube gripping portion 480 and the nut engagement portion 482 are clamped relatively toward one another, the tube gripping portion and the nut engagement portion move as indicated by arrows 490, 491 into engagement with the tube 12. The tube indenting edge 20 plastically deforms the tubing 12 to provide a seal between the gripping member 18 and the tube 12. The nut engagement portion 482 engages the tube 12 to damp any vibrations of the tube.

According to another aspect of the present application, a fitting component may be provided with a tube reinforcement structure adapted to support a tube end inserted into a fitting. Many different structures may be used, such as, for example, a shoulder or recess on the fitting body or in a separate gland or gasket that receives an end of the tube. This engagement with the tube end may serve to reinforce or back up the end of the tubing, thereby providing support for the forces applied by the fitting to the tubing, such as the force that is applied to plastically deform the tube material and form a seal. The reinforcement structure may support the tube against both outward and inward radial deformation and may extend into the tube bore to provide this support. FIGS. 35-40 illustrate examples of tube fitting reinforcement structures 500 that engage an end 34 of the tube such that at least a portion of a radial load applied to the tube by the tube gripping member is supported by the reinforcement structure 500.

In the example illustrated by FIG. 35, the reinforcement structure 500 comprises an annular wedge shaped groove 502 defined in a sealing member 504 that provides a seal between the tube gripping member 18 (represented schematically in FIG. 35) and the fitting body (not shown). An edge 506 defined by the groove 502 engages an end face of the tube 12 to reinforce the tube against load applied by the gripping member 18. As shown in FIG. 35, the groove 502 may, but need not, be contoured to allow the tubing 12 to deform on pull up, thereby providing reinforcement to the deformed portion of the tube 12.

In the example illustrated by FIG. 36, a gasket 510 provides a seal between the fitting body 14 and a gland member 512. The reinforcement structure comprises an annular groove 514 defined in the gasket 510. A radially inner annular surface 516 engages an inner surface 518 of the tube 12 to reinforce the tube against load applied by the gripping member (not shown). Since the exemplary reinforcement structure is provided with a gasket 510 that seals with an end surface of the fitting body 14, the tube gripping member and the tubing 12 can be separated from the fitting body 14 without substantial axial movement of the tubing with respect to the fitting body when the fitting body and the nut are disassembled.

In the example illustrated by FIG. 37, a gasket 520 provides a seal between the fitting body 14 and a gland member 522. The reinforcement structure 500 comprises an annular groove 524 with an inclined surface 526 defined in the gasket 520. The inclined surface 526 engages an inner surface 528 of the tube 12 to reinforce the tube against load applied by the gripping member (not shown). Since the exemplary reinforcement structure is provided with a gasket 520 that seals with an end surface of the fitting body 14, the fitting can be disassembled and reassembled without substantial axial movement of the tubing with respect to the fitting body 14, or substantially zero axial clearance.

In the example illustrated by FIG. 38, a gasket 530 provides a seal between the fitting body 14 and the tube gripping member 18. The fitting body 14 includes an annular sealing projection 532 that seals with the gasket 530. The reinforcement structure comprises an annular groove 534 with an inclined surface 536 defined in the gasket 530. The inclined surface 536 engages an inner surface 538 of the tube 12 to reinforce the tube against load applied by the gripping member 18. Since the exemplary reinforcement structure is provided with a gasket 530 that seals with an end surface of the fitting body 14, the fitting can be disassembled and reassembled with substantially zero axial clearance between the fitting body 14 and the tube 12.

In the example illustrated by FIG. 39, a gasket 540 provides a seal between the fitting body 14 and the tube gripping member 18. The fitting body 14 includes an annular sealing projection 542 that seals with the gasket 540. In the example illustrated by FIG. 39, the annular sealing projection 542 is aligned with the annular line of contact 543 where the tube gripping member 18 engages the gasket 540. As a result, force applied to the gasket 540 by the tube gripping member 18 is transferred to the annular sealing projection 542. The reinforcement structure comprises an annular groove 544 with an inclined surface 546 defined in the gasket 540. The inclined surface 546 engages an inner surface 548 of the tube 12 to reinforce the tube against load applied by the gripping member 18. Since the exemplary reinforcement structure is provided with a gasket 540 that seals with an end surface of the fitting body 14, the fitting can be disassembled and reassembled with substantially zero axial clearance between the fitting body 14 and the tube 12.

In the example illustrated by FIG. 40, a gasket 550 provides a seal between the fitting body 14 and the tube gripping member (not shown). The fitting body 14 includes an annular sealing projection 552 that seals with the gasket 550. In the example illustrated by FIG. 40, the annular sealing projection 552 is aligned with the tube wall. The reinforcement structure 500 comprises an annular groove 554 with an inclined surface 556 defined in the gasket. The inclined surface 556 engages an inner surface 558 of the tube 12 to reinforce the tube against load applied by the gripping member. Since the exemplary reinforcement structure is provided with a gasket 550 that seals with an end surface of the fitting body 14, the fitting can be disassembled and reassembled with substantially zero axial clearance between the fitting body 14 and the tube 12.

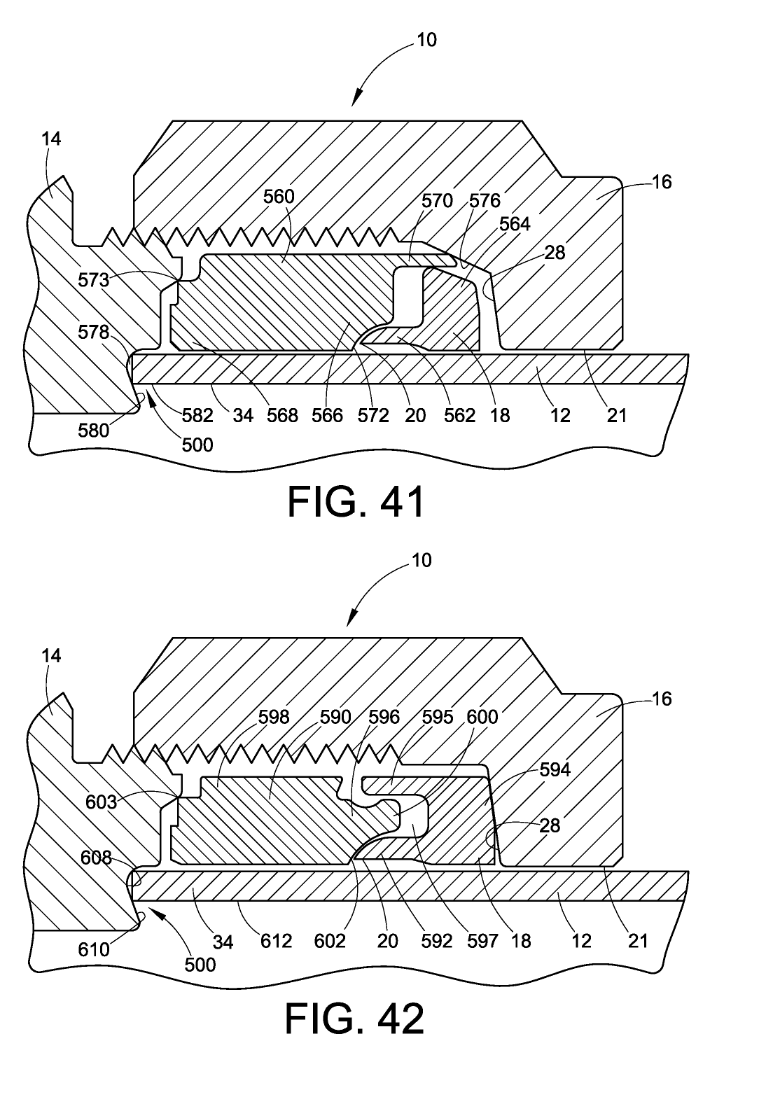

According to an aspect of the present application, a fitting may be provided with a separate component adapted to drive a tube gripping member into engagement with a tube, which upon pull-up may become permanently attached to the tube gripping member engaged with the tube. In one such embodiment, the separate component may include a cam member provided with a camming surface for directing the tube gripping member into engagement with the tube. In the example illustrated by FIG. 41, the fitting 10 includes a fitting body 14, a nut 16, a tube gripping member 18, and a cam member 560. The tube gripping member 18 includes an annular tube gripping portion 562 and an annular nut engagement portion 564. The tube gripping portion 562 is elongated and relatively narrow to permit deflection. The cam member 560 includes a tube gripping member engagement portion 566 and a fitting body engagement portion 568. The tube gripping member engagement portion 566 includes an annular camming surface 572. The fitting body engagement portion 568 includes a sharp annular cutting surface 573. When the fitting is pulled up, the tube gripping portion 562 is deflected by the camming surface 572 into engagement with the tube 12. The tube indenting edge 20 plastically deforms the tubing 12 to provide a seal between the gripping member 18 and the tube 12 when the fitting is pulled up. When the fitting is pulled up, the sharp annular cutting surface 573 cuts into the fitting body 14 to provide a seal between the fitting body 14 and the cam member 560.

The cam member may be provided with structure for engaging the nut during pull up to seal the cam member against the nut. In the embodiment of FIG. 41, the tube gripping member engagement portion 566 of the cam member 560 includes a circumferential wall 570. The nut 16 includes an inclined cam member drive surface 576 that engages the circumferential wall 570 during pull up to secure the circumferential wall around the nut engagement portion 564 of the tube gripping member 18. When the fitting is disassembled, the tube gripping member 18 remains connected to the tube 12 and the cam member 560 remains assembled to the tube gripping member 18. In the example illustrated by FIG. 41, the fitting body 14 includes a tube reinforcement structure 500 that engages an end 34 of the tube. The exemplary reinforcement structure comprises an annular groove 578 with an inclined surface 580 defined in the end of the fitting body 14. The inclined surface 580 engages an inner surface 582 of the tube 12 to reinforce the tube against load applied by the gripping member 18.

In the example illustrated by FIG. 42, the fitting 10 includes a fitting body 14, a nut 16, a tube gripping member 18, and a cam member 590. The tube gripping member 18 includes an annular tube gripping portion 592, an annular nut engagement portion 594, and a circumferential wall 595. The tube gripping portion 592 and the circumferential wall 595 extend axially from the nut engagement portion 594 to define an annular recess 597. The exemplary tube gripping portion 592 is elongated and relatively narrow to permit deflection. The cam member 590 includes a tube gripping member engagement portion 596 and a fitting body engagement portion 598. The portion 596 includes an annular projection 600 and an annular camming surface 602. The fitting body engagement portion 598 includes a sharp annular cutting surface 603. When the fitting is pulled up, the tube gripping portion 592 is deflected by the camming surface 602 into engagement with the tube 12. The tube indenting edge 20 plastically deforms the tubing 12 to provide a seal between the gripping member 18 and the tube 12 when the fitting is pulled up. The cam member annular projection 600 is extends into the annular recess 597 upon pull up. When the fitting is pulled up, the sharp annular cutting surface 603 cuts into the fitting body 14 to provide a seal between the fitting body and the cam member 590. In the example illustrated by FIG. 42, the fitting body 14 includes a tube reinforcement structure 500 that engages an end 34 of the tube. The reinforcement structure comprises an annular groove 608 with an inclined surface 610 defined in the end of the fitting body. The inclined surface 610 engages an inner surface 612 of the tube 12 to reinforce the tube against load applied by the gripping member 18.

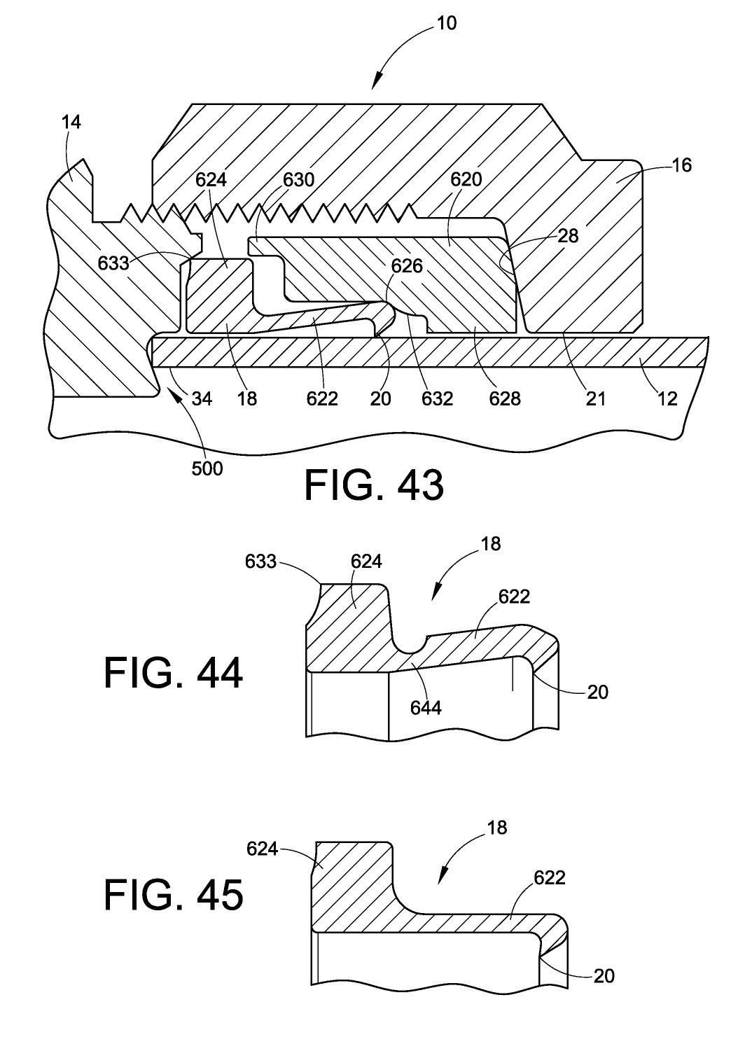

While FIGS. 41 and 42 illustrate embodiments in which the tube gripping member is disposed between the nut and the cam member, in another embodiment, the cam member may be disposed between the nut and the tube gripping member. In the example illustrated by FIG. 43, the fitting 10 includes a fitting body 14, a nut 16, a tube gripping member 18, and a cam member 620. The tube gripping member 18 includes an annular tube gripping portion 622 and an annular fitting body engagement portion 624. The fitting body engagement portion 624 includes a sharp annular cutting surface 633. The exemplary tube gripping portion 622 is elongated and relatively narrow to permit deflection. The annular tube indenting edge 20 is defined at the end of the tube gripping portion 622. The cam member 620 includes a tube gripping member engagement portion 626 and a nut engagement portion 628. The tube gripping member engagement portion 626 includes a circumferential wall 630 and an annular camming surface 632. When the fitting is pulled up, the tube gripping portion 622 is deflected by the camming surface 632 into engagement with the tube 12. The tube indenting edge 20 plastically deforms the tube 12 to provide a seal between the gripping member 18 and the tube 12 when the fitting is pulled up. When the fitting is pulled up, the sharp annular cutting surface 633 cuts into the fitting body 14 to provide a seal between the fitting body and the tube gripping member 18. When the fitting is disassembled, the tube gripping member 18 remains connected to the tube. In the example illustrated by FIG. 43, the fitting body 14 includes a tube reinforcement structure 500 that engages and supports an end 34 of the tube 12.

FIG. 44 illustrates an example of a tube gripping member 18 that can be used in the fitting illustrated by FIG. 43. In the example illustrated by FIG. 44, the annular tube gripping portion 622 includes an area of reduced thickness 644. In this example, the area of reduced thickness 644 flexes and the tube indenting edge 20 rotates into engagement with the tube 12 when the fitting is pulled up. In one embodiment, the tube gripping portion 622 is hardened and the area of reduced thickness 644 is not hardened to allow the area of reduced thickness to flex.

In one aspect of the application, a fitting component, such as a tube gripping member, may be made from a shape memory alloy. Many different shape memory alloys may be used. Some examples of suitable shape memory alloy are disclosed in U.S. provisional patent application Ser. No. 60/652,932, entitled “Carburizing Shape Memory Stainless Steels,” filed on Jan. 10, 2005, which is incorporated herein by reference in its entirety. FIG. 45 illustrates one example of a tube gripping member 18 that can be constructed in a shape memory alloy to be used, for example, in the fitting 10 illustrated by FIG. 43. FIG. 45 illustrates the shape of the gripping member when the gripping member is secured to the tube by the fitting. The gripping member is machined in this shape and is treated (either before or after machining) to remember the illustrated shape of FIG. 45. The exemplary tube gripping member 18 is then flared open to produce a tube gripping member having the shape illustrated by FIG. 43. The tube 12 is inserted into the fitting 10 and the tube gripping member 18 is treated to cause the tube gripping member to tend to return to the remembered shape. For example, the gripping member may be heated to cause the gripping member to tend to return to the remembered shape. The assembled fitting is pulled up as described with reference to FIG. 43. When the fitting is disassembled, the gripping member 18 will not tend to separate from the tube, because the gripping member will retain the remembered shape when assembled with the tubing.

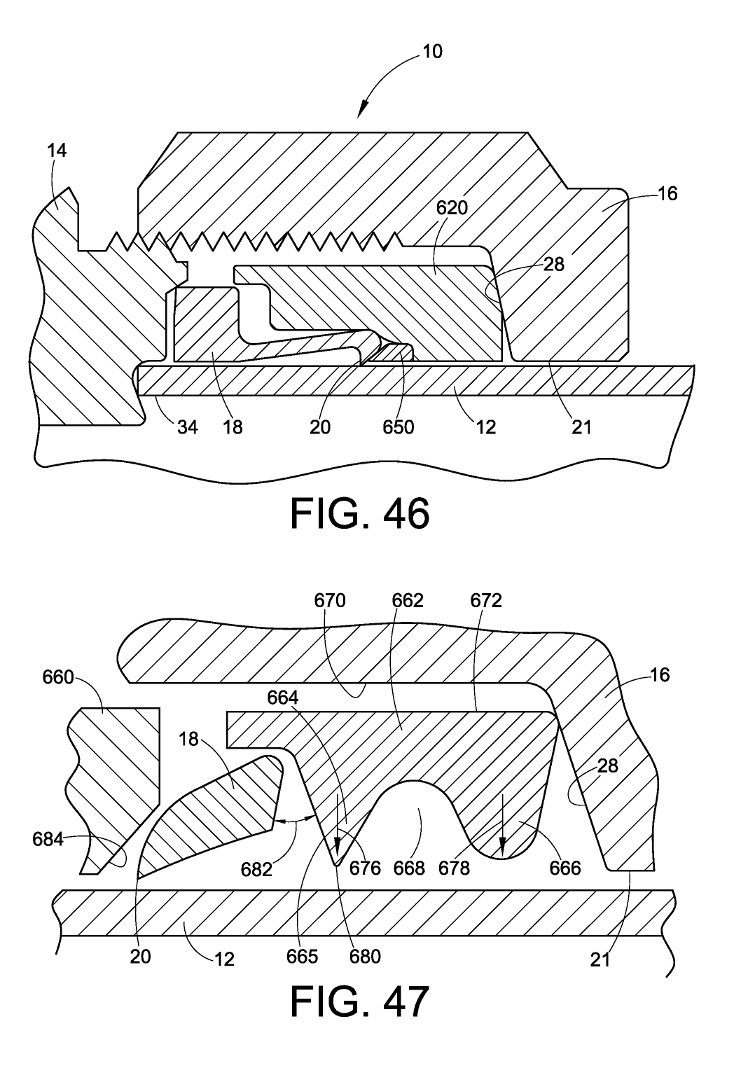

According to another aspect of the present application, a substance, such as, for example, a lubricant, may be applied to one or more fitting components, such as a tube gripping member or cam member, to enhance fitting performance. For example, a lubricant may be applied to a fitting component to attenuate vibrations, retard oxidation, and/or disperse debris. FIG. 46 illustrates a variation of the fitting 10 illustrated by FIG. 43 where a lubricant 650 is deposited on the tube gripping member 18 and the cam member 620. The lubricant 650 is displaced onto the tube during pull up. Examples of suitable lubricants and methods of applying the lubricants to tube fittings are disclosed in U.S. provisional patent application 60/652,631, entitled “Fitting with Lubricated Ferrule,” filed on Feb. 14, 2005 and published United States patent application Publication Number 2003155045, Ser. No. 10/358,946, entitled “Lubricated Low Temperature Case Hardened Article,” filed on Feb. 5, 2002, which are incorporated herein by reference in their entireties.

According to the present application, a fitting may be provided with multiple tube gripping members to provide additional sealing locations against a tube. In one such embodiment, one of the tube gripping members may perform some additional function, such as, for example, engagement with the tube to dampen vibrations. In the example illustrated by FIG. 47, the fitting includes a fitting body (not shown), a sealing member 660, a tube gripping member 18, a tube gripping and colleting member 662, and a nut 16. The tube gripping and colleting member 662 includes an annular tube gripping portion 664 and an annular nut engagement portion 666. An annular recess 668 is defined between the tube gripping portion 664 and the annular nut engagement portion 666 to allow the tube gripping portion and the nut engagement portion to flex toward one another. The tube gripping portion 664 includes a gripping member drive surface 665 that engages the tube gripping member 18. The nut 16 includes an annular interior surface 670. When the fitting is pulled up, the tube gripping portion 664 engages the tube gripping member 18 and the nut engagement portion 666 engages the nut drive surface 28. A radially outer surface 672 of the tube gripping and colleting member 662 engages the interior nut surface 670. As the tube gripping portion 664 and the nut engagement portion 666 are clamped relatively toward one another, the tube gripping portion and the nut engagement portion move as indicated by arrows 676, 678 into engagement with the tube 12. An indenting edge 680 plastically deforms the tubing 12 along a circumferential line of engagement to provide a seal between the gripping and colleting member 662 and the tube 12. The nut engagement portion 666 engages the tube 12 to damp any vibrations of the tube. An angular gap 682 is defined by a difference angle between the gripping member 18 and the gripping member drive surface 665. The sealing member 660 includes an annular camming surface 684. The camming surface 684 and the angular gap 682 direct the gripping member 18 into the tubing 12 to provide a seal between the gripping member 18 and the tube 12 when the fitting is pulled up. The gripping member 18 engages and seals against the sealing member 660 when the fitting 10 is pulled up.

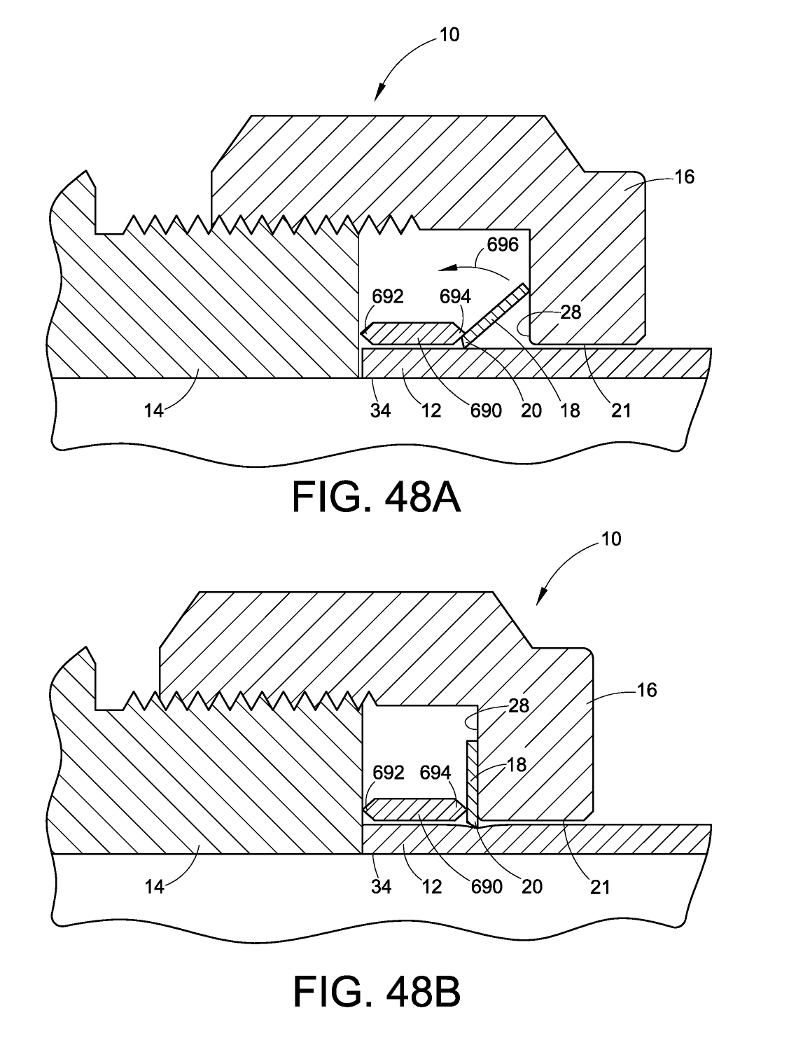

According to another aspect of the present application, a sealing member may be provided with a first sealing portion for sealing against a fitting body and a second sealing portion for sealing against a tube gripping member. As one example, these sealing portions may include indenting edges adapted to cut into the fitting body and gripping member when the fitting is tightened. In the example illustrated by FIGS. 48A and 48B, the fitting 10 includes a fitting body 14, a nut 16, a tube gripping member 18, and a sealing member 690. The tube gripping member 18 illustrated by FIGS. 48A and 48B is a spring washer that includes a radially inner tube indenting edge 20. The sealing member 690 is a cylindrical tube that includes a an annular body indenting edge 692 at one end and an annular gripping member indenting edge 694 at the opposite end. Referring to FIG. 48A, the tube indenting edge 20 is initially positioned under the gripping member indenting edge 694. When the fitting is pulled up, a nut drive surface 28 engages and rotates the spring washer 18 as indicated by arrow 696, while driving the tube indenting edge 20 into the tube. The tube indenting edge 20 plastically deforms the tubing 12 to provide a seal between the gripping member 18 and the tube 12 when the fitting is pulled up. Referring to FIG. 48B, when the fitting 10 is pulled up, the annular body indenting edge 692 cuts into the fitting body 14 to provide a seal between the fitting body and the sealing member 690. The gripping member indenting edge 694 cuts into the gripping member 18 to provide a seal between the sealing member 690 and the tube gripping member 18. In one embodiment, when the fitting 10 is disassembled, the tube gripping member remains connected to the tube. In this embodiment, the gripping member may, but need not, be made from an annealed material, with a hardened indenting edge or case such that the gripping member remains deformed once pulled up. In another embodiment, the gripping member 18 disengages from the tube 12 when the fitting 10 is disassembled. In this embodiment, the gripping member may, but need not, be made from a strain hardened material that retains some elastic spring back after pull up that causes the tube indenting edge 20 to disengage the tube 12 upon disassembly. As one variation of the example illustrated by FIGS. 48A and 48B, the orientation of the annular gripping member 18 may be reversed, such that the tube indenting edge 20 is adjacent the drive surface 28. In this configuration, the tube is forced into the fitting body 14 by the body indenting edge during pull up. In the example illustrated by FIGS. 48A and 48B, the fitting can be disassembled and reassembled with substantially zero axial clearance between the fitting body 14 and the tube 12.

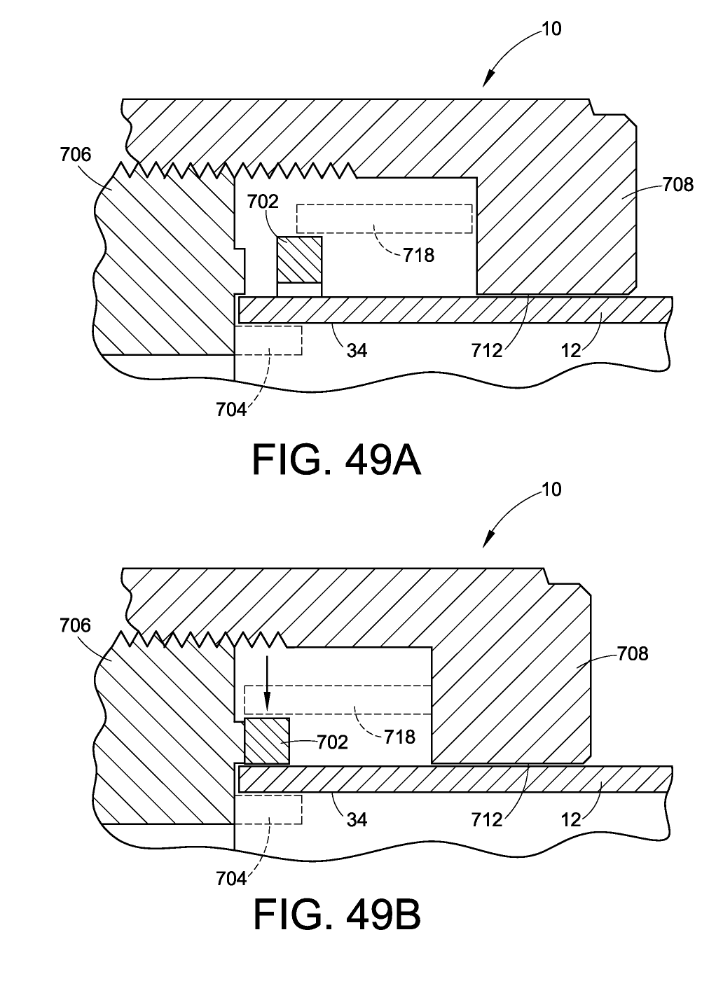

According to another aspect of the present application, a fitting may provide a seal between a tube gripping member and a tube, such as, for example, thin walled tube, by clamping the tube between the tube gripping member and a reinforcement structure. FIGS. 49A and 49B schematically illustrate an exemplary fitting 10 according to such an embodiment. The fitting illustrated by FIGS. 49A and 49B provides a seal between a tube gripping member 702 and the tube by clamping the tube between the tube gripping member 702 and a reinforcement structure, shown schematically at 704. In this embodiment, the tube gripping member 702 may have a sharp or dull edge. The reinforcement structure 704 reinforces the tube 12 to allow a gas seal to be formed between a gripping member 702 having a dull edge and the tube 12. The fitting 10 illustrated by FIGS. 49A and 49B includes a fitting body 706, a nut 708, the reinforcement structure 704, and the annular tube gripping member 702. The nut 708 is assembled with the fitting body 706. A tube 12 having a substantially cylindrical end portion 34 is inserted through an annular bore 712 of the nut 708 into the fitting 10. The reinforcement structure 704 engages an interior surface of the end portion 34 of the tube 12. The annular tube gripping member 702 is assembled between the fitting body 706 and the nut 708. Referring to FIG. 49B, a clamping structure, shown schematically at 718, applies force to the tube gripping member 702 to clamp the cylindrical tube end 34 against the reinforcement structure 704 when the fitting body 706 and the nut 708 are tightened to provide a seal between the tube gripping member 702 and the tube 12. The reinforcement structure 704 may be defined as part of the fitting body or may be formed as part of a separate member. The clamping structure 718 that forces the gripping member 702 into engagement with the tube may be defined by one or more of the nut 708, the fitting body 706, the gripping member 702, and additional members disposed in the fitting that coact with the nut, fitting body and/or the gripping member. In the example illustrated by FIGS. 49A and 49B, the reinforcement structure 704 assists the tube in resisting the clamping or swaging forces, which may be of particular benefit when used with thin walled tubing or tubing made of soft material.

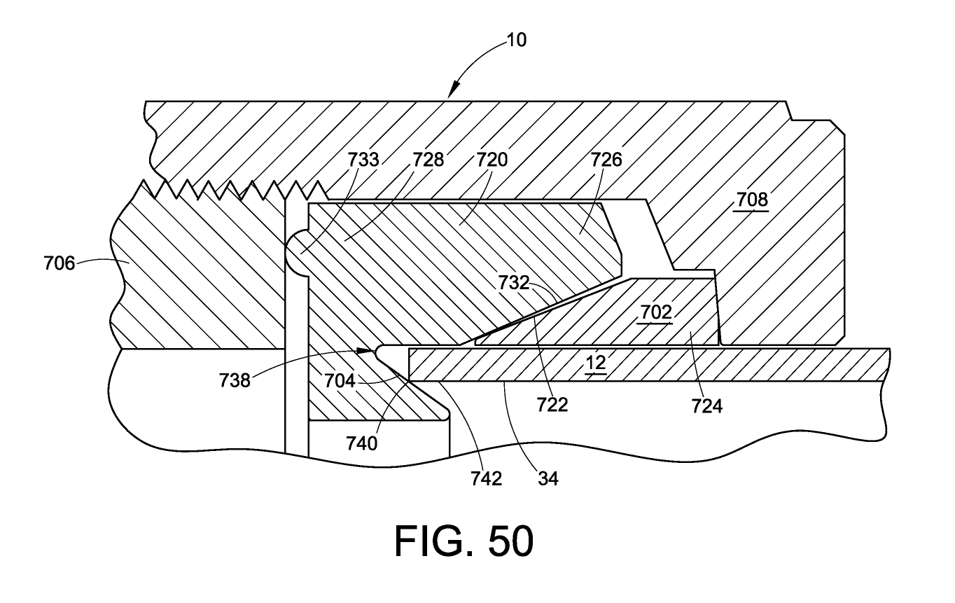

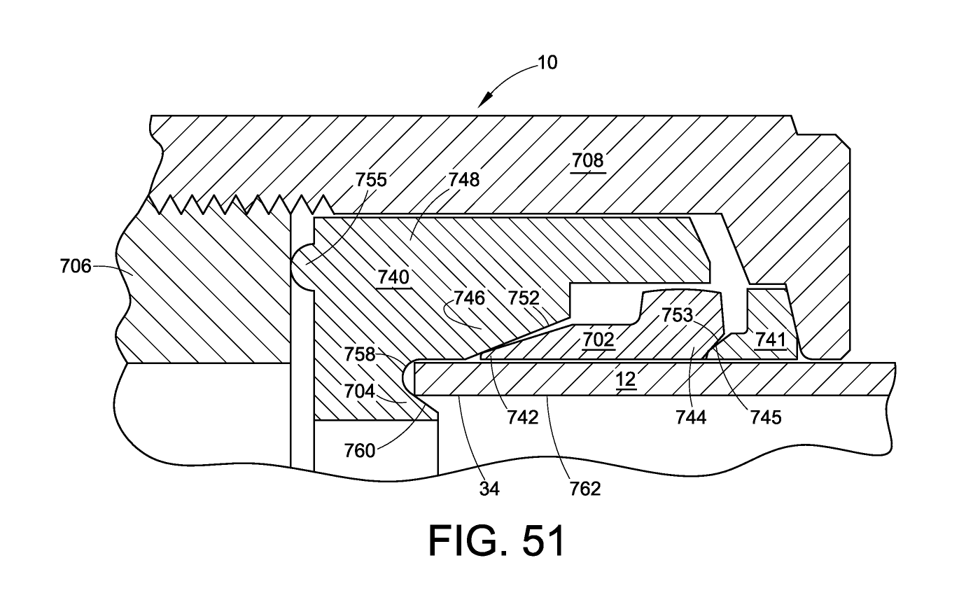

FIGS. 50 and 51 illustrate examples of fittings 10 that may be used with different types of tubing, including thin walled tubing. In the example illustrated by FIG. 50, the fitting 10 includes a fitting body 706, a nut 708, a tube gripping member 702, and a sealing member 720. The tube gripping member 702 includes an annular tube gripping portion 722 and an annular nut engagement portion 724. The sealing member 720 includes a tube gripping member engagement portion 726, a fitting body engagement portion 728, and a tube reinforcement structure 704 that engages an end 34 of the tube. The reinforcement structure 704 comprises an annular groove 738 with an inclined surface 740. The inclined surface 740 engages an inner surface 742 of the tube 12. The engagement portion 726 defines an annular caroming surface 732. The fitting body engagement portion 728 includes an annular sealing protrusion 733. When the fitting is pulled up, the tube gripping portion 722 is directed by the camming surface 732 into engagement with the tube 12. The tube gripping portion 722 clamps the tube 12 against the inclined surface 740 of the sealing structure 704 to provide a seal between the gripping member 722 and the tube 12 when the fitting is pulled up. When the fitting is pulled up, the sealing protrusion 733 seals against the fitting body. In the example illustrated by FIG. 50, the fitting can be disassembled and reassembled with substantially zero axial clearance between the fitting body 14 and the tube 12.

In the example illustrated by FIG. 51, the fitting 10 includes a fitting body 706, a nut 708, a tube gripping member 702, a sealing member 740, and a drive member 741. The tube gripping member 710 includes an annular tube gripping portion 742 and an annular drive member engagement portion 744. The drive member engagement portion 744 includes an inclined drive surface 745. The sealing member 740 includes a tube gripping member engagement portion 746, a fitting body engagement portion 748, and a tube reinforcement structure 704 that engages an end 34 of the tube 12. The reinforcement structure 704 comprises an annular groove 758 with an inclined surface 760. The inclined surface 760 engages an inner surface 762 of the tube. The engagement portion 746 defines an annular camming surface 752. The drive member 741 includes an inclined drive surface 753 that cooperates with the inclined surface of the gripping member during pull up. The fitting body engagement portion 748 includes an annular sealing protrusion 755. When the fitting is pulled up, the tube gripping portion 742 is directed by the camming surface 752 into engagement with the tube 12. The tube gripping portion 742 clamps the tube against the inclined surface 760 of the sealing structure 704 to provide a seal between the gripping member 722 and the tube 12 when the fitting is pulled up. When the fitting is pulled up, the sealing protrusion 755 seals against the fitting body. In the example illustrated by FIG. 51, the fitting can be disassembled and reassembled with substantially zero axial clearance between the fitting body 14 and the tube 12.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1-86. (canceled)

87. A tube fitting comprising:
a fitting body having a central axis; said fitting body comprising a recess adapted to receive a tube end,
a fitting nut that can be assembled with said fitting body,
a spring washer comprising a radially outer edge and a radially inner edge; wherein after the tube fitting is tightened onto a tube end, said radially outer edge will engage an inner surface of said fitting body and said radially inner edge will plastically deform a surface of the tube end to provide a seal between said spring washer and said tube end,
wherein said spring washer pivots about said radially outer edge in a direction towards said recess.

88. The tube fitting of claim 87 wherein said fitting body comprises a bore that receives said spring washer, said bore comprising said inner surface of said fitting body.

89. The tube fitting of claim 88, wherein said bore comprises an annular recess that receives said radially outer edge of said spring washer.

90. The tube fitting of claim 87 wherein said radially inner edge comprises case hardened stainless steel.

91. The tube fitting of claim 87 wherein said radially outer edge engages and seals against said fitting body when the tube fitting is tightened on a tube end.

92. The tube fitting of claim 87 wherein said fitting body, said fitting nut and said spring washer all comprise stainless steel.

93. The tube fitting of claim 87 wherein the tube end comprises a wall thickness less than or equal to 1/10 of an outside diameter of the tube end, and an outside diameter of approximately 0.250 inches and a wall thickness of less than or equal to 0.028 inches.

94. The tube fitting of claim 1 wherein said fitting body and said fitting nut are threadably joined together when the tube fitting is tightened onto a tube end.

95. A tube fitting comprising:
a fitting body having a central axis; said fitting body comprising a recess with a tube end disposed therein, said fitting body comprising a bore with a surface, said tube end comprising an outer surface,
a fitting nut,
a spring washer disposed in said bore and between said fitting body and said fitting nut, said spring washer comprising a radially outer edge and a radially inner edge; said tube end outer surface comprising a plastic deformation produced by said radially outer edge of said spring washer with a seal between said spring washer and said tube end outer surface,
said spring washer radially outer surface being engaged with said bore surface, and
said spring washer being in a pivoted position from an unstressed position, about said radially outer edge in a direction towards said recess.
